(19) United States
(12) Patent Application Publication
(10) Pub. No.: US 2026/0307011 A1
(43) Pub. Date: Oct. 8, 2026

(54) MODIFIED POLYVINYLIDENE FLUORIDE MEMBRANES FOR WATER FILTRATION

(71) Applicant: UCHICAGO ARGONNE, LLC, Chicago, IL (US)

(72) Inventors: Jeffrey W. ELAM, Elmhurst, IL (US); Bratin SENGUPTA, Westmont, IL (US)

(73) Assignee: UCHICAGO ARGONNE, LLC, Chicago, IL (US)

(21) Appl. No.: 19/532,870

(22) Filed: Feb. 6, 2026

Related U.S. Application Data
(60) Provisional application No. 63/784,641, filed on Apr. 7, 2025.

(51) Int. Cl. B01D 61/14; B01D 53/22; B01D 61/02

(52) U.S. Cl. CPC B01D 61/145; B01D 53/228; B01D 61/025

(57) ABSTRACT

A process for modifying polyvinylidene fluoride (PVDF) membranes for water filtration includes contacting the membrane with a solution of hydroxide in water at a temperature of about 65° C. to about 85° C. for about 0.5 hours to about 24 hours to form a pretreated membrane. The process also includes depositing a coating on the pretreated membrane by an ALD process to form a modified membrane. The depositing includes (A) contacting the pretreated membrane with a precursor gas to form a precursor complex on a surface of the pretreated membrane; and (B) contacting the pretreated membrane with a co-reactant, the co-reactant reactive with the precursor complex.

### CROSS-REFERENCE TO RELATED APPLICATIONS

This application claims the benefit of and priority to U.S. Provisional Patent Application No. 63/784,641, filed Apr. 7, 2025, the entire contents of which are incorporated herein by reference.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to water filtration membranes, particularly modified polyvinylidene fluoride membranes for water filtration.

### BACKGROUND

Water scarcity is a serious global issue, with millions of people struggling to access clean freshwater. Desalination, the process of removing salt from salt water to make it drinkable, has been developed to address this problem. As traditional freshwater sources become less available, desalination offers a way to provide water where it is needed. However, desalination also faces challenges, such as membrane fouling.

### SUMMARY

Membrane fouling is a ubiquitous problem in water treatment and plagues a wide range of industries including the dairy and beverage industries.

In one aspect, a method includes contacting a membrane comprising polyvinylidene fluoride (PVDF) with a solution comprising about 4 N to about 10 N hydroxide in water at a temperature of about 65° C. to about 85° C. for about 0.5 hours to about 24 hours to form a pretreated membrane; and depositing a coating on the pretreated membrane by a vapor-phase deposition process to form a coated membrane, the depositing including: (A) contacting the pretreated membrane with a precursor gas to form a precursor complex on a surface of the pretreated membrane; and (B) contacting the pretreated membrane with a co-reactant, the co-reactant reactive with the precursor complex.

In any embodiment, the solution may include sodium hydroxide, potassium hydroxide, barium hydroxide, calcium hydroxide, lithium hydroxide, rubidium hydroxide, magnesium hydroxide, trimethylammonium hydroxide, or a combination of any two or more thereof. Contacting the membrane may include contacting the membrane with the solution for about 0.5 hours to about 5 hours at a temperature of about 70° C. to about 80° C., and the solution is about 4 N to about 5 N sodium hydroxide in water. Depositing the coating may include providing the pretreated membrane in an atomic layer deposition (ALD) reactor; contacting the pretreated membrane with the precursor gas in the ALD reactor while heating the pretreated membrane at a temperature of about 50° C. to about 110° C.; and contacting the pretreated membrane with the co-reactant in the ALD reactor while heating the pretreated membrane at a temperature of about 50° C. to about 110° C. The precursor gas may include an aluminum precursor, a zinc precursor, a titanium precursor, a tin precursor, a zirconium precursor, a silicon precursor, a niobium precursor, or a combination of any two or more thereof. The precursor gas may include trimethyl aluminum (TMA), triethyl aluminum, aluminum chloride, dimethyl aluminum isopropoxide, aluminum bromide, aluminum t-butoxide, tris(dimethylamido)aluminum (III), aluminumacetylacetonate, or aluminum isopropoxide. The co-reactant may be selected from water (H₂O), oxygen (O), ozone (O₃), hydrogen peroxide (H₂O₂), nitrous oxide (N₂O), or a combination of any two or more thereof. Depositing the coating may further include repeating steps (A) and (B) 1 to 50 times. The method may include contacting the membrane with ethanol prior to contacting the membrane with the solution including hydroxide.

In another aspect, a membrane is disclosed including PVDF with pores formed therein having a diameter of about 10 nm to 10 μm; and a metal oxide coating disposed on the PVDF, the metal oxide coating having a thickness of about 0.1 nm to about 20 nm; wherein the membrane has a water permeance of about 1000 L·m⁻²·h⁻¹·bar⁻¹ to about 1300 L·m⁻²·h⁻¹·bar⁻¹ and a flux recovery of about 80% to about 99.9%.

In any embodiment, the pores may have a diameter of about 10 nm to about 99 nm. The pores may have a diameter of about 0.1 μm to about 10 μm. The metal oxide coating may include aluminum oxide, zinc oxide, titanium oxide, tin oxide, zirconium oxide, silicon oxide, niobium oxide, or a combination of any two or more thereof.

In another aspect, a method of filtering an aqueous liquid includes passing the aqueous liquid through a membrane at a permeance of about 1000 L·m⁻²·h⁻¹·bar⁻¹ to about 1300 L·m⁻²·h⁻¹·bar⁻¹; backwashing the membrane; and after backwashing, passing the aqueous liquid through the membrane again with a flux recovery of about 80% to about 99.9%.

In any embodiment, the membrane may include polyvinylidene fluoride (PVDF) with pores formed therein having a diameter of about 10 nm to about 10 μm; and a metal oxide coating disposed on the PVDF, the metal oxide coating having a thickness of about 0.1 nm to about 20 nm. The pores may have a diameter of about 10 nm to about 99 nm. The pores may have a diameter of about 0.1 μm to about 10 μm. The metal oxide coating may include aluminum oxide, zinc oxide, titanium oxide, tin oxide, zirconium oxide, silicon oxide, niobium oxide, or a combination of any two or more thereof.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a flow diagram of a method of modifying a PVDF membrane.

FIG. 1B is a flow diagram of another method of modifying a PVDF membrane.

FIG. 2 is an illustration of another method of modifying a PVDF membrane and the modified membrane. Super hydrophobic PVDF membranes are pretreated with hydroxide to impart ALD growth moieties. Then, ALD using trimethyl alumina (TMA) and water (H₂O) is used to grow an ultrathin layer of aluminum oxide, which imparts super hydrophilicity and positive charge to the membrane surface, rendering the modified membrane antifouling against organic matters in water.

FIG. 3 is a flow diagram of a method of using a modified PVDF membrane.

FIGS. 4A-4D: Characterization of delayed growth of atomic layer deposition (ALD) and PVDF pretreatment. FIG. 4A is a graph of normalized peak area observed from X-ray photoelectron spectroscopy (XPS) for aluminum oxide growth via ALD on a silicon wafer and on PVDF. Normalization was with respect to each of the saturated peak area at 150 cycles and greater.

FIG. 4B is a graph of oxygen content (left axis) of the pretreated PVDF membranes after 5 hours of pretreatment with UV-O₃, O₃, or NaOH, or after pretreatment with 1 hour of O₂ plasma, and the oxygen peak area relative to PVDF (right axis) after the pretreatment as measured by XPS. FIG. 4C is a graph of fluorine content (left axis) and carbon content (right axis) as measured by XPS of PVDF pretreated with NaOH for different amounts of time. Results indicate NaOH pretreatment of PVDF results in de-fluorination and sp² carbon formation in PVDF, as indicated by the loss of total fluorine (left axis), decrease in C—F bonds, and increase in total sp² carbon (right axis) with pretreatment time. FIG. 4D is a graph of FTIR reflectance spectra for PVDF after various modification carried out in FIG. 4B, the pristine PVDF spectrum has been subtracted from each of them.

FIGS. 5A-5G: Characterization of ALD modified pretreated PVDF membranes. FIG. 5A is a graph of the surface atomic percent (at %) of aluminum in aluminum oxide as measured by XPS after 20 ALD Al₂O₃ cycles following different pretreatments (pristine (no pretreatment), 5 hours UV-O₃, 5 hours O₃, 5 hours NaOH, or 0.5 hours O₂ plasma). The right axis plots the aluminum XPS signal relative to the signal from the pristine PVDF. FIG. 5B is a graph of selectivity of Al₂O₃ ALD using TMA as the metal precursor and H₂O as the co-reactant (surface Al at % compared to pristine PVDF) for different modified PVDF surfaces after ALD. Larger bubbles indicate greater numbers of ALD cycles (noted beside each data point). Inset: Selectivity of Al₂O₃ALD after different numbers of ALD Al₂O₃ cycles following O₃ pretreatment. FIG. 5C is a graph of growth selectivity for 20 cycles of ALD growth for 3 different metal oxides—Al₂O₃, TiO₂ and ZnO—on two of the pretreated PVDF surfaces (NaOH pretreatment or UV-O₃ pretreatment). Inset: The respective surface at % of the metals on a pristine PVDF membrane. FIG. 5D is a graph of changes in the surface chemistry of NaOH-PVDF with varying numbers of ALD cycles. FIG. 5E is a graph of FTIR spectra for NaOH-PVDF after different numbers of Al₂O₃ALD cycles with the spectra of NaOH-PVDF subtracted from them. FIG. 5F is plan-view SEM images of surface morphology—the pristine PVDF membrane (left) and 20 ALD cycles-modified NaOH-PVDF membrane (right). The inset shows membrane pores in higher magnification in each case. FIG. 5G is cross-sectional SEM images (pristine PVDF on left, 20 ALD cycles-modified NaOH-PVDF on right) show that the internal pore structure is unchanged and EDS elemental map (inset on right) shows a uniform aluminum distribution.

FIGS. 6A-6D: Characterization of wettability and antifouling characteristics of PVDF. FIG. 6A is a graph of sessile drop water contact angle (WCA) for pristine PVDF and PVDF after 5 hours of NaOH, UV-O₃, or O₃ pretreatment or 30 mins of O₂ plasma pretreatment. FIG. 6B is a graph of WCA after 20 cycles of Al₂O₃ deposited on pristine and pretreated PVDF. FIG. 6C is a graph of initial WCA of NaOH-pretreated PVDF modified with different numbers of ALD cycles. Inset: WCA of just 1 cycle ALD reduced to 0° within about 10 seconds of touching the surface, while it remained constant for pristine PVDF and 1 cycle of ALD on pristine PVDF. WCA measurements were taken after 3 seconds, except for NaOH-PVDF, where the water drop disappeared instantaneously after it touched the surface. FIG. 6D is a graph of Zeta potential measurements of surface charge of PVDF and NaOH-PVDF membranes before and after 20 Al₂O₃ALD cycles.

FIGS. 7A-7D: Characterization of antifouling performance of modified PVDF membranes. FIG. 7A is a graph of long-term filtration operation of membranes (pristine PVDF, ALD-PVDF, NaOH-PVDF and ALD NaOH-PVDF) with pure water as feed, followed by feed containing humic acid solution as feed. Following membrane fouling, these membranes were cleaned, and pure water was used as feed again to understand the permeance recovery through these membranes. FIG. 7B is a graph of pure water permeance through the membranes in FIG. 7A, and the total organic foulant contents in the permeate. FIG. 7C is a graph of parameters describing the antifouling properties of the membrane—flux recovery, reversible and irreversible decline in flux through the membranes. FIG. 7D is a graph of theoretically calculated surface energy and work of adhesion for the membranes.

FIGS. 8A-8E: Oil water separation performance of modified membranes. FIG. 8A is a series of photograph stills from a video of unwater oil-membrane adhesion testing for 20 cycles of ALD modified NaOH-PVDF membranes. FIG. 8B is a graph of cyclic washing and fouling test for these two membranes. FIG. 8C is a graph of antifouling properties (permeance recovery, reversible and irreversible decline in permeance) through the NaOH-PVDF membranes modified with different cycles of ALD. These properties were measured after 4 hours of membrane fouling.

FIG. 8D is a graph of water production during oil-water separation and the oil rejection at the end of the 4 hours of membrane operation. FIG. 8E is graph of over 100 hour long term testing for crude oil-water emulsion separation using the PVDF and 20 cycles of ALD treated NaOH PVDF membranes. Inset: The feed (left), permeate (middle) and retentate (right) collected at the end of the 100-hour long operation of the NaOH-PVDF membrane treated with 20 cycles of ALD. All membrane performance in FIGS. 8B-8D were evaluated using soyabean oil-water emulsion.

FIGS. 9A-9C: Morphology and chemistry of surface modified PVDF membranes. FIG. 9A provides plan view (left) and cross-sectional (right) SEM micrographs showing the surface morphology of metal oxide surface modified membranes. The inset of FIG. 9A provides EDS scans showing uniform distribution of metals on the membrane surface. Membranes were modified with Al₂O₃, SnO₂, TiO₂ and ZnO, as indicated by the elements listed in the insets. FIG. 9B is a graph of ALD selectivity after 20 cycles ALD for various metal oxides for pristine PVDF and alkali activated PVDF membranes. Right axis: metal at. % on the surface modified membranes. FIG. 9C is a graph of FTIR spectra of surface modified membranes modified with different metal oxides. These spectra were subtracted from the alkali modified PVDF spectrum.

FIGS. 10A-10E: Oil water separation characteristics of surface modified PVDF membranes. FIG. 10A is a graph of water contact angles (WCA) of the surface modified (SM) PVDF membranes modified with different metal oxides. Dashed line is the WCA of alkali activated PVDF. FIG. 10B is a graph of time dependent WCA of SM PVDF membranes showing that SM PVDF membranes reach 0° WCA within 10 seconds (inset). FIG. 10C is a graph of zeta potential of SM PVDF membranes; red dashed line represents zeta potential of alkali activated PVDF membrane. FIG. 10D is a graph of work of adhesion and van der Waals surface energy of various metal oxide surfaces. FIG. 10E is a graph of energy due to surface polar components due to acid and basic sites and total surface polar components of four different metal oxides.

FIGS. 11A-11D: Oil water separation performance of surface modified PVDF and control membranes. FIG. 11A is a graph of pure water permeance of SM PVDF membranes; dashed line represents the pure water permeance of alkali activated PVDF membrane. FIG. 11B is a graph of water production (left axis) and separation efficiency (right axis) using SM PVDF membranes in 2 hours during 3% crude oil-water emulsion separation. Dashed lines indicate water production and separation efficiency using the alkali activated PVDF membrane. FIG. 11C is a graph of fouling parameters of the SM PVDF membranes: left is permeance recovery and right is permeance decline with reversible and irreversible components. FIG. 11D is a graph comparing fouling parameters of Ti-SM PVDF membranes with control membranes, PVDF, alkali activated PVDF and TiO₂-PVDF membranes.

FIGS. 12A-12C: Permeance, water recovery, and crude oil enrichment using surface modified PVDF membrane. FIG. 12A is a graph of permeance during long term oil-water separation using Ti-SM PVDF and pristine PVDF membranes. FIGS. 12B and 12C are graphs of fraction of water recovered in permeate compared to the total water in the feed (left axis) and enrichment of crude oil in the retentate compared to the initial crude oil concentration in the feed (right axis) for Ti-SM PVDF and pristine PVDF, respectively.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “membrane” refers to a selective barrier that allows certain molecules or ions to pass through it while blocking others. The membrane may be a polymer with a plurality of pores formed therein that provide selective permeability. The membrane may be a thin (e.g., about 1 μm to about 1 cm, about 1 μm to about 5 mm, about 1 μm to about 1 mm, about 1 μm to about 500 μm, about 1 μm to about 100 μm, about 1 μm to about 50 μm, about 10 μm to about 40 μm, or any value or subrange therebetween) pliable sheet of polymer with the plurality of pores formed therein.

The selective permeability of the membrane may be useful for processes like filtration and separation (e.g., in water purification, dairy processing, and beverage manufacturing). For example, the membrane may be a microfiltration membrane with pores of about 0.1 μm-10 μm. The microfiltration membrane may provide pass through of water, dissolved mineral salts, and sugars; while blocking bacteria, protozoa, and suspended solids. As another example, the membrane may be a water ultrafiltration membrane with pores of about 0.01 μm-0.1 μm. The ultrafiltration membrane may provide pass through of water, dissolved minerals, and sugars; while blocking bacteria, protozoa, suspended solids, and some viruses.

Polyvinylidene fluoride (PVDF) is a useful material for ultrafiltration membranes and microfiltration membranes. PVDF is a thermally stable (e.g., having a melting point of about 170° C.) and chemically resistant material (e.g., resistant to certain acids, bases, and solvents). PVDF also has favorable mechanical properties for processability and for use as a membrane (e.g., having a tensile strength of about 40 MPa to about 60 MPa, a flexural strength of about 80 MPa to about 100 MPa, a compressive strength of about 70 MPa to about 100 MPa, and a Rockwell hardness of about R110 to about R115). PVDF membranes may be used as stand-alone water filtration membranes, or as part of larger water treatment systems. For example, PVDF membranes may be used as part of a desalination system, where they are used as a filtration membrane.

However, PVDF is hydrophobic, making it more prone to fouling. Fouling is the accumulation of organic or biological materials on a membrane surface during filtration, which reduces the throughput of the membrane. Fouling is a grand challenge for membrane applications, especially for aqueous separations. A way to mitigate or prevent fouling and extend membrane lifetime is to reduce the interaction between the foulant and membrane surface. This may be achieved by increasing the interaction energy between the foulant and the membrane surface via membrane surface modification. Post-synthetic membrane modification provides alteration of membrane surface properties targeting anti-fouling properties, without substantially changing the membrane fabrication technique.

Conventional methods of post-synthetic modification of PVDF membranes have proven unsatisfactory. Conventional solution-phase post-synthesis modification of PVDF membranes may cause problems with control of pore size. For example, solution-phase modification may shrink pore sizes, detrimentally decreasing throughput. Conventional vapor-phase modification has suffered from poor nucleation on PVDF. Pristine PVDF lacks sufficient chemical moieties to serve as well-dispersed nucleation sites for vapor-phase deposition growth. Hence, vapor-phase deposition conventionally requires larger numbers of deposition cycles to grow sufficient amounts of metal oxides to realize anti-fouling properties. Poor nucleation may cause sparse growth of large metal oxide islands, especially at the pores, due to limited diffusion during the precursor desorption step of the ALD cycle. Large metal oxide islands localized at pores may constrict the diameter of the pore, causing reduction in water throughput. Moreover, such large numbers of vapor-phase deposition cycles may prove challenging for scalable applications.

Disclosed herein are methods of modifying PVDF membranes, modified PVDF membranes, and methods of using modified PVDF membranes. The methods of modifying PVDF membranes may include pretreatment to form oxygen-containing groups (e.g., hydroxyl groups) at the surface of the PVDF membrane, followed by modification with a vapor-phase deposition of metal oxide on the PVDF membrane, where the hydroxyl groups at the surface formed during pretreatment facilitate deposition of the metal oxide.

The vapor-phase deposition may be used to form an ultra-thin (e.g., a thickness of less than 10 nm, less than 5 nm, or less than 2 nm) metal oxide coating that may be orders of magnitude smaller than the pores of the membrane. The metal oxide coating may be an anti-fouling coating. The metal oxide coating may preserve pore size (e.g., pore size reduction of less than 50%, less than 40%, less than 30%, less than 20%, less than 10%, less than 5%, less than 2%, less than 1%, or less than 0.1%), structure, and material properties of the pristine membrane. The metal oxide coating may retain similar or improved permeance and separation performance as compared to the pristine membrane.

The metal oxide coating may impart a positive surface charge to the membrane, which may increase the interaction energy between a foulant and the membrane, and may thereby reduce or prevent membrane fouling.

The metal oxide coating may impart hydrophilicity or even superhydrophilicity to the membrane. The water contact angle of the membrane prior to vapor-phase deposition may be about 160° to about 95° (e.g., about 150° to about 100°, about 140° to about 100°, about 130° to about 110°, about 120°, or any value or subrange therebetween). Following vapor-phase deposition, the membrane may have a water contact angle of less than 90° (e.g., 0° to about 90°, 0° to about 60°, 0° to about 30°, 0° to about 10°, 0° to about 5°, 0° to about 4°, 0° to about 3°, 0° to about 2°, or 0° to about 1°, or any value or subrange therebetween).

The vapor-phase deposition may be chemical vapor deposition (CVD). For example, the CVD may be atomic layer deposition (ALD). ALD is a scalable, vapor phase self-limiting thin film deposition technique. ALD can be used to deposit metal oxides of various metals. The coating may be continuous and conformally deposited on surfaces of the membrane, including within the pores of the membrane.

In an aspect, the method of modifying the PVDF membrane includes contacting the membrane with a solution comprising hydroxide in water at a temperature for a time to form a pretreated membrane; and depositing a coating on the pretreated membrane by a vapor-phase deposition process to form a coated membrane.

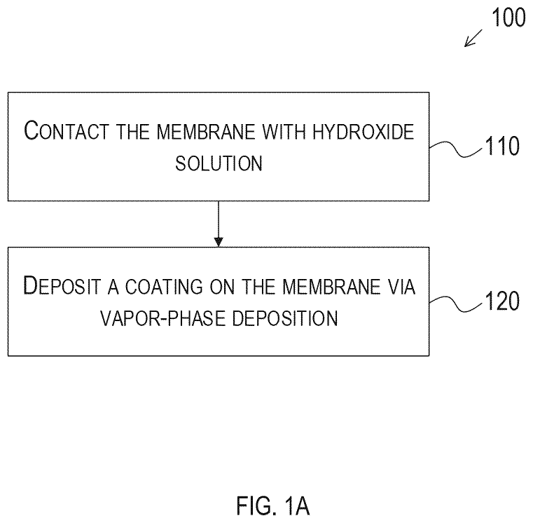

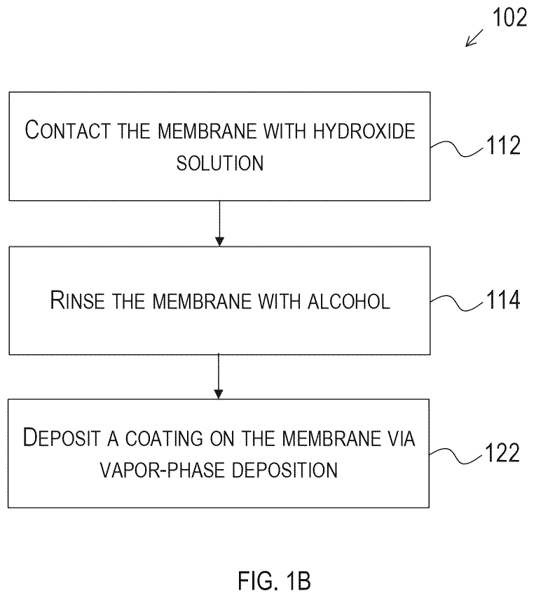

FIG. 1A is a flow diagram of a method 100 of modifying a PVDF membrane. The method 100 includes the step 110 of contacting the membrane with hydroxide solution. The step 110 may provide hydroxyl groups on the surface of the PVDF membrane.

Step 110 may include contacting the membrane with the solution at the temperature for about 0.5 hours to about 24 hours. For example, contacting the membrane may include contacting the membrane with the solution at the temperature for about 0.5 hours to about 20 hours, about 0.5 hours to about 15 hours, about 0.5 hours to about 10 hours, about 0.5 hours to about 5 hours, about 0.5 hours to about 5 hours, about 0.5 hours to about 4 hours, about 0.5 hours to about 3 hours, about 0.5 hours to about 2 hours, about 0.5 hours to about 1 hours, about 0.5 hours to about 0.8 hours, about 0.5 hours, or any value or subrange therebetween.

During step 110, the hydroxide solution may be at a temperature of about 50° C. to about 100° C. (e.g., about 50° C. to about 100° C., about 50° C. to about 85° C., about 60° C. to about 90° C., about 65° C. to about 85° C., about 70° C. to about 80° C., about 75° C., or any value or subrange therebetween).

The hydroxide solution may include sodium hydroxide, potassium hydroxide, barium hydroxide, calcium hydroxide, lithium hydroxide, rubidium hydroxide, magnesium hydroxide, trimethylammonium hydroxide, or a combination of any two or more thereof. The hydroxide solution may be about 4 N to about 10 N hydroxide in water (e.g., about 4 N to about 8 N, about 4 N to about 7 N, about 4 N to about 6 N, about 4 N to about 5 N, about 5 N to about 6 N, or any value or subrange therebetween). For example, the hydroxide solution may be about 4 N to about 5 N sodium hydroxide in water.

The method 100 includes the step 120 of depositing a coating on the pretreated membrane via vapor-phase deposition. Depositing the coating may be facilitated by the oxygen-containing groups provided on the pretreated membrane in step 110.

The vapor-phase deposition may be ALD. The step 120 may include providing the pretreated membrane in an ALD reactor. The step 120 may include (A) contacting the pretreated membrane with a first precursor gas to form a first precursor complex on a surface of the treated membrane; and (B) contacting the pretreated membrane with a co-reactant, the co-reactant reactive with the precursor complex. Steps (A) and (B) may constitute 1 ALD cycle.

Specifically, each vapor-phase deposition process may include a cycle or multiple repeated cycles, where cycles may be repeated to form a predetermined film thickness. For ALD, a cycle includes introducing a precursor into a reactor via a precursor vapor pulse for an exposure time, followed by a purge, such as where the reactor is pumped to a vacuum to remove excess precursor, followed by a co-reactant pulse with a co-reactant exposure time followed by a co-reactant purge. It should be appreciated that the dose and purge time may be based on the self-limiting behavior of the precursors/co-reactants and the desired precursor utilization efficiency. The exposure time may be varied in a wide range from a few milliseconds to tens of minutes. Further if a longer dose than purge time is utilized, the times may be increased to avoid a CVD-type reaction, which can result in non-uniformity and particle formation.

The ALD process may take place in a uniform temperature-controlled reactor. The reactor and/or the substrate may be heated to a predetermined temperature during the ALD process. For example, the predetermined temperature can be in the range of about 50° C. to about 120° C. (e.g., about 50° C. to about 110° C., about 50° C. to about 100° C., about 50° C. to about 95° C., about 50° C. to about 85° C., about 55° C. to about 85° C., about 60° C. to about 85° C., about 65° C. to about 85° C., about 70° C. to about 85° C., about 75° C. to about 85° C., about 80° C. to about 85° C., about 75° C. to about 85° C., about 80° C., or any value or subrange therebetween). In some embodiments, the predetermined temperature is in the range of 75-85° C. (e.g., 80° C.). Temperature also impacts the overall energy in the system and the performance for diffusion and/or reaction. In a given ALD process, the deposition temperature range may be the temperature range in which ALD deposition occurs at an approximately static growth rate as a function of temperature, which is referred to as the “ALD window.” The ALD reaction may occur at a temperature of the precursor sufficient to provide an approximately constant precursor evaporation rate (i.e., vapor pressure). If the precursor vapor pressure is insufficient to react with the reactive surface sites, there may still be layer growth, but the surface coverage may be less complete due to incomplete precursor saturation. If the vapor pressure is too high, precursor may be wasted, and CVD growth may occur if there is not sufficient purge time to remove the excess precursor. The temperature of the layer growth may be as low as the subliming or evaporation temperature of the ALD precursors. For example, if a precursor sublimes at 50° C., films may be grown around that temperature or a temperature higher than the sublimation temperature. In some embodiments, layer growth temperature may be at least 10-50° C. higher than the precursor sublimation temperature. Further, a plasma may be used as the co-reactant or to enhance the growth rate or tailor the composition of the deposited layer or make the deposited material crystalline. Additionally or alternatively, the temperature may be a temperature at which the substrate is stable.

The precursor gas may be, for example, a material reactive or absorbable on the pretreated membrane to form a first precursor complex. The metal precursor may be a vapor and the metal precursor pulse may introduce the metal precursor vapor into the reactor for a pulse time of a few milliseconds to tens of seconds (e.g., 0.005, 0.01, 0.05, 0.1, 0.5, 1, 5, 10, 20, or 30 seconds, inclusive of all ranges and values therebetween). The metal precursor partial pressure of the pulse may be in the range of 0.01-1000 Torr (e.g., 0.1, 0.2, 0.3, 0.4, 0.5, 0.6, 0.7, 0.8, 0.9, 1, 2, 3, 4, 5, 6, 7, 8, 9, 10, 25, 50, 75, 100, 500, or 1000 Torr, inclusive of all ranges and values therebetween), such as, for example, at least 0.3-100 Torr. One of skill in the art will appreciate that the time length, pressure, and amount of precursor for the pulse are all factors in determining the overall amount for each of those operation parameters. For example, the pressure and amount may follow from the duration of the pulse but depend on the size of the chamber and the type of valve as would be understood from general knowledge regarding ALD. Note, for ease of reference herein, the process is described with regard to the pulse duration, but it should be understood that the precursor partial pressure is another means to control the precursor dose. For spatial ALD, the precursor exposure is controlled by the amount of time the substrate (e.g., membrane) spends in the precursor spatial domain and the precursor partial pressure in the precursor spatial domain. A carrier gas, such as nitrogen, argon, or other non-reactive (with the substrate or the precursors) gas, may be used.

The metal precursor exposure may include exposing the substrate (i.e., the membrane) to the metal precursor for a predetermined exposure time and a predetermined partial pressure so that the metal precursor adsorbs to the substrate or a coating from prior ALD cycles on the substrate or forms a reactive species complex with the substrate or the coating from prior ALD cycles. The metal precursor exposure may include contacting the pretreated membrane with the precursor gas in the ALD reactor while heating the pretreated membrane at the predetermined temperature. In some embodiments, given the brief time for the pulse/exposure for the ALD process the pulse lasts the entire exposure until the purge starts with the pulse time and exposure time being the same. The metal precursor pulse time may be less than the exposure time, or they may be equal such that the exposure is the same as the pulse. The metal precursor exposure time can be in the range of 0.5-2000 seconds (e.g., 0.5, 1, 5, 10, 20, 30, 40, 50, 60, 70, 80, 90, 100, 120, 140, 160, 180, 200, 220, 240, 260, 280, 300, 350, 400, 450, 500, 1000, or 2000 seconds, inclusive of all ranges and values therebetween), such as about 1 second. In some embodiments, the exposure time is in the range of 1-500 seconds. ALD growth may also be performed at various reactor pressures (e.g., 10⁻⁴ Torr to 1000 Torr).

The metal precursor purge evacuates unreacted precursor from the reactor. The metal precursor purge may be for a precursor purge time of 0.5-2000 seconds (e.g., 0.5, 1, 5, 10, 20, 30, 60, 120, 240, 300, 400, 500, 1000, or 2000 seconds, inclusive of all ranges and values therebetween), such as 60 seconds. The precursor purge may evacuate the reactor such that the total pressure in the reactor is reduced substantially to vacuum. Alternatively, the precursor purge may consist of a constant flow of high purity carrier gas at a constant pressure that sweeps the unreacted precursor from the reactor. In either case, the precursor purge reduces the partial pressure of the precursor in the reactor by a factor of 10² to >10⁹ (e.g., from an initial value of 1 Torr immediately following the precursor exposure to a final value after the first precursor purge of 10⁻² to <10⁻⁹ Torr).

The membrane may be exposed to a co-reactant. The co-reactant is reactive with the metal precursor adsorbed on the substrate or reactive species complex resulting from the metal precursor's reaction with the substrate. Exposing the pretreated membrane to the co-reactant may include contacting the pretreated membrane with the co-reactant in the ALD reactor while heating the pretreated membrane at the predetermined temperature. The co-reactant may be introduced into the reactor for a co-reactant exposure time and at a partial pressure of the co-reactant so that co-reactant reacts with the surface sites formed by the metal precursor reacting with the substrate (or previous ALD deposited coatings). The co-reactant exposure time may be in the range of 0.5-2000 seconds (e.g., 0.5, 1, 5, 10, 20, 30, 40, 50, 60, 70, 80, 90, 100, 120, 140, 160, 180, 200, 220, 240, 260, 280, 300, 350, 400, 450, 500, 1000, or 2000 seconds, inclusive of all ranges and values therebetween), such as about 1 second. The partial pressure of the co-reactant may be in the range of 0.01-10 Torr (e.g., 0.01, 0.05, 0.1, 0.5, 1.0, 5.0, or 10 Torr, inclusive of all ranges and values therebetween). In some embodiments, the partial pressure of the co-reactant is in the range of 0.1-1 Torr (e.g., about 0.5 Torr or 0.88 Torr). ALD growth may also be performed in various reactor pressures (10⁻⁴ Torr to 1000 Torr).

The co-reactant purge evacuates unreacted co-reactant from the reactor. The co-reactant purge may be for a co-reactant purge time of 0.5-2000 seconds (e.g., 0.5, 1, 5, 10, 20, 30, 40, 50, 60, 70, 80, 90, 100, 120, 140, 160, 180, 200, 220, 240, 260, 280, 300, 350, 400, 450, 500, 1000, or 2000 seconds, inclusive of all ranges and values therebetween), such as 60 seconds. The co-reactant purge may evacuate the reactor such that the total pressure is reduced substantially to vacuum. Alternatively, the co-reactant purge may consist of a constant flow of high purity carrier gas at a constant pressure that sweeps the unreacted co-reactant from the reactor. In either case, the co-reactant purge reduces the partial pressure of the co-reactant in the reactor by a factor of 10² to >10⁹ (e.g., from an initial value of 1 Torr immediately following the co-reactant exposure to a final value after the co-reactant purge of 10⁻² to <10⁻⁹ Torr).

The steps of introducing the metal precursor and then the co-reactant into the reactor as described above, which is 1 ALD cycle, may be repeated to deposit a uniform two-component coating on the substrate (e.g., only Al₂O₃, ZnO, or TiO₂). Step 120 may include depositing about 1 to about 50 cycles of ALD on the pretreated membrane (e.g., about 1 to about 40 cycles, about 1 to about 30 cycles, about 1 to about 20 cycles, about 1 to about 10 cycles, about 1 to about 5 cycles, about 1 to about 2 cycles, about 15 cycles to about 25 cycles, or any value or subrange therebetween).

In some implementations, additional precursors and/or co-reactants may be sequentially introduced into the reactor as part of a supercycle. The ALD process may include a supercycle or multiple repeated supercycles. A supercycle combines ALD cycles for two or more ALD processes. For instance, a supercycle combining two ALD processes includes performing one or more ALD cycles for a first ALD process followed by one or more ALD cycles for a second ALD process. Supercycles may be used to form layered films, doped films, and/or gradient coating. Gradient coatings may be formed by varying the number of ALD cycles of each ALD process included in the supercycle as the coating is deposited.

It should be appreciated that more complicated ALD schemes can be constructed as super-cycles. Super-cycles may include various sub-cycles for depositing a material, for depositing multiple different materials, for multiple doped coatings, or for depositing bi- (tri-, etc.) metallic materials. The material deposited may vary based on the deposition parameters for any of the individual steps within a super-cycle. For example, the deposition may be a doped layer, a multilayer, a nanocomposite, or a mixed metal oxide composite. The respective pulse and purge times may be the same time or may be different for the different metal precursors and co-reactants.

The metal precursor for depositing coatings including aluminum constituents may include, for example, trimethyl aluminum (TMA), triethyl aluminum, aluminum chloride, dimethyl aluminum isopropoxide, aluminum bromide, aluminum t-butoxide, tris(dimethylamido)aluminum (III), aluminumacetylacetonate, aluminum isopropoxide, or a combination of any two or more thereof.

The metal precursor for depositing coatings including zinc constituents may include, for example, diethyl zinc, dimethyl zinc, zinc acetylacetonate hydrate, bis(2,2,6,6-tetramethyl-3,5-heptanedionato) zinc, or a combination of any two or more thereof.

The metal precursor for depositing coatings including titanium constituents may include, for example, titanium tetrachloride, tetrakis(diethylamino)titanium (IV), tetrakis(dimethylamino)titanium (IV), pentamethylcyclopentadienyltitanium trimethoxide, titanium t-butoxide, titanium (IV) i-propoxide, or a combination of any two or more thereof.

The metal precursor for depositing coatings including tin constituents may include, for example, tetrakis(dimethylamino) tin, tetrakis(diethylamino) tin, bis(N,N′-diisopropylformamidinato tin(II), tin chloride, tin iodide, tin t-butoxide, tetrakis(dimethylamido) tin(IV), tetrakis(diethylamido) tin(IV), tetramethyltin, tetraethyltin, tin(II) acetylacetonate, dimethylamino-2-methyl-2-butoxy tin, or a combination of any two or more thereof.

The metal precursor for depositing coatings including zirconium constituents may include, for example, tetrakis(dimethylamino) zirconium (IV), tetrakis(diethylamino) zirconium (IV), tetrakis(ethylmethylamino) zirconium (IV), bis(cyclopentadienyl)dimethylzirconium, zirconium (IV) n-butoxide, zirconium (IV) t-butoxide, zirconium chloride, zirconium (IV) i-propoxide, or a combination of any two or more thereof.

The metal precursor for depositing coatings including silicon constituents may include, for example, silicon tetrachloride, tri-t-butoxysilanol, bis(dimethylamino)dimethylsilane, 3-aminopropyltriethoxysilane, tris(dimethylamino)silane, or a combination of any two or more thereof.

The metal precursor for depositing coatings including niobium constituents may include, for example, trihydridobis(pentamethylcyclopentadienyl)niobium(V), niobium(V) ethoxide, niobium pentachloride, niobium pentafluoride, (t-tutylimido) tris(diethylamino)niobium(V), or a combination of any two or more thereof.

The co-reactant for depositing coatings including oxygen constituents may include, for example, water (H₂O), oxygen (O), ozone (O₃), hydrogen peroxide (H₂O₂), nitrous oxide (N₂O), or a combination of any two or more thereof.

Step 120 may deposit a metal oxide coating having a thickness of about 0.1 nm to about 20 nm. For example, the thickness may be about 1 nm to about 20 nm, about 5 nm to about 20 nm, about 10 nm to about 20 nm, about 0.1 nm to about 10 nm, about 0.1 nm to about 5 nm, about 0.1 nm to about 4 nm, about 0.1 nm to about 3 nm, about 0.1 nm to about 2 nm, about 0.1 nm to about 1 nm, about 0.1 nm to about 0.5 nm, about 0.1 nm, about 0.2 nm, about 0.3 nm, about 0.4 nm, about 0.5 nm, about 0.6 nm, about 0.7 nm, about 0.8 nm, about 0.9 nm, or any value or subrange therebetween.

The method 100 may further include contacting the membrane with alcohol prior to or after step 110. The alcohol may be ethanol, methanol, isopropanol, butanol, or a combination of any two or more thereof. The alcohol may be 100 proof to 200 proof (e.g., about 150 proof to about 200 proof, about 180 proof to about 200 proof, about 190 proof, or any value or subrange therebetween). The membrane may be soaked in the alcohol for about 0.1 hour to about 24 hours (e.g., about 0.5 hours to about 20 hours, about 0.5 hours to about 15 hours, about 0.5 hours to about 10 hours, about 0.5 hours to about 5 hours, about 0.5 hours to about 5 hours, about 0.5 hours to about 4 hours, about 0.5 hours to about 3 hours, about 0.5 hours to about 2 hours, about 0.5 hours to about 1 hours, about 0.5 hours to about 0.8 hours, about 0.5 hours, or any value or subrange therebetween).

FIG. 1B is a flow diagram of another method 102 of modifying a PVDF membrane. The method 102 includes the step 112 of contacting the membrane with hydroxide solution. The step 112 may provide hydroxyl groups on the surface of the PVDF membrane. Step 112 may include any of the elements described with respect to step 110 in FIG. 1A.

The method 102 includes the step 114 of contacting the membrane with alcohol. The alcohol may be ethanol, methanol, isopropanol, butanol, or a combination of any two or more thereof. The alcohol may be 100 proof to 200 proof (e.g., about 150 proof to about 200 proof, about 180 proof to about 200 proof, about 190 proof, or any value or subrange therebetween). The membrane may be soaked in the alcohol for about 0.1 hour to about 24 hours (e.g., about 0.5 hours to about 20 hours, about 0.5 hours to about 15 hours, about 0.5 hours to about 10 hours, about 0.5 hours to about 5 hours, about 0.5 hours to about 5 hours, about 0.5 hours to about 4 hours, about 0.5 hours to about 3 hours, about 0.5 hours to about 2 hours, about 0.5 hours to about 1 hours, about 0.5 hours to about 0.8 hours, about 0.5 hours, or any value or subrange therebetween).

The method 102 includes the step 122 of depositing a coating on the pretreated membrane via vapor-phase deposition. Depositing the coating may be facilitated by the oxygen-containing groups provided on the pretreated membrane in step 112. Step 122 may include any of the elements described with respect to step 120 in FIG. 1A.

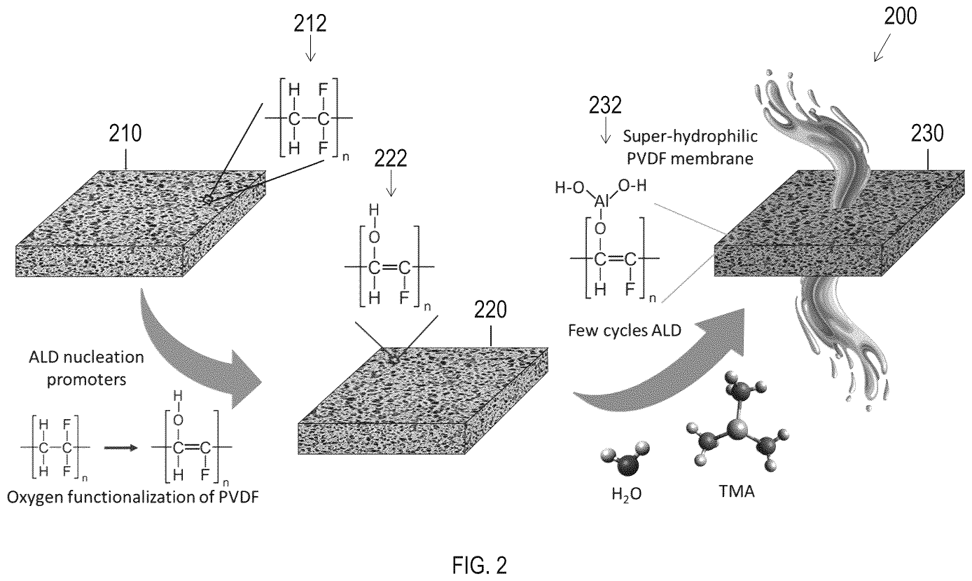

FIG. 2 is an illustration of another method 200 of modifying a PVDF membrane and the modified membrane 230. The PVDF membrane 210 may be a pristine hydrophobic PVDF membrane having surface C—H and C—F groups 212. The PVDF membrane 210 may be pretreated with hydroxide to impart functional groups to facilitate ALD, forming a pretreated PVDF membrane 220 with surface hydroxyl groups 222. Then, cycles (e.g., 1-50 cycles) of ALD may be deposited on the pretreated membrane 220 according to the methods disclosed herein using trimethyl alumina (TMA) and water (H₂O) to grow an ultrathin layer of aluminum oxide, forming the modified membrane 230. The modified membrane 230 includes alumina and/or hydroxyl groups 232, which may provide hydrophilicity and anti-fouling properties.

In another aspect, a membrane is disclosed including PVDF and a metal oxide coating disposed on the PVDF, the metal oxide coating having a thickness of about 0.1 nm to about 20 nm. The membrane may be an ultrafiltration membrane, a nanofiltration membrane, or a combination thereof. The membrane may be formed via any of the methods disclosed herein.

PVDF membranes may be composed of PVDF, copolymers including PVDF, and polymer blends including PVDF. For example, the membrane may be entirely made of PVDF. As another example, the membrane may be formed of a copolymer or polymer blend, where the polymers include PVDF and one or more additional polymers. Nonlimiting examples of additional polymers may include polyethylene terephthalate (PET), polyvinyl chloride (PVC), polyvinylidene fluoride (PVDF), polypropylene (PP), polyether sulfone (PES), polyacrylonitrile (PAN), polytetrafluoroethylene (PTFE), polyacrylamide, derivatives thereof, or a combination of any two or more thereof.

The PVDF membrane may have a pore diameter (also referred to herein as pore size) of about 10 nm to about 10 μm. Ultrafiltration membranes may have a pore diameter of about 10 nm to 99 nm. For example, the pore diameter may be about 10 nm to about 90 nm, about 10 nm to about 80 nm, about 10 nm to about 70 nm, about 10 nm to about 60 nm, about 10 nm to about 50 nm, about 10 nm to about 40 nm, about 10 nm to about 30 nm, about 10 nm to about 20 nm, about 20 nm to about 99 nm, about 30 nm to about 99 nm, about 40 nm to about 99 nm, about 50 nm to about 99 nm, about 60 nm to about 99 nm, about 70 nm to about 99 nm, about 80 nm to about 99 nm, or any value or subrange therebetween. Microfiltration membranes may have a pore diameter of 0.1 μm to about 10 μm. For example, the pore diameter may be about 0.1 μm to about 9 μm, about 0.1 μm to about 8 μm, about 0.1 μm to about 7 μm, about 0.1 μm to about 6 μm, about 0.1 μm to about 5 μm, about 0.1 μm to about 4 μm, about 0.1 μm to about 3 μm, about 0.1 μm to about 2 μm, about 0.1 μm to about 1 μm, about 1 μm to about 9 μm, about 2 μm to about 9 μm, about 3 μm to about 9 μm, about 4 μm to about 9 μm, about 5 μm to about 9 μm, about 6 μm to about 9 μm, about 7 μm to about 9 μm, about 8 μm to about 9 μm, or any value or subrange therebetween.

The metal oxide coating may have a thickness of about 0.1 nm to about 20 nm. For example, the thickness may be about 1 nm to about 20 nm, about 5 nm to about 20 nm, about 10 nm to about 20 nm, about 0.1 nm to about 10 nm, about 0.1 nm to about 5 nm, about 0.1 nm to about 4 nm, about 0.1 nm to about 3 nm, about 0.1 nm to about 2 nm, about 0.1 nm to about 1 nm, about 0.1 nm to about 0.5 nm, about 0.1 nm, about 0.2 nm, about 0.3 nm, about 0.4 nm, about 0.5 nm, about 0.6 nm, about 0.7 nm, about 0.8 nm, about 0.9 nm, or any value or subrange therebetween.

The metal oxide coating may include aluminum oxide, zinc oxide, titanium oxide, zinc oxide, titanium oxide, tin oxide, zirconium oxide, silicon oxide, niobium oxide, or a combination of any two or more thereof. For example, the metal oxide coating may be aluminum oxide. For example, the metal oxide coating may be zinc oxide. For example, the metal oxide coating may be titanium dioxide. As another example, the metal oxide coating may include two or more metal oxides as a doped layer, multilayer, or nanocomposite, as disclosed herein. For example, the metal oxide coating may include layers of different metal oxides chosen from the group consisting of aluminum oxide, zinc oxide, titanium oxide, zinc oxide, titanium oxide, tin oxide, zirconium oxide, silicon oxide, niobium oxide, or a combination of any two or more thereof, where the layers form a nanometer-scale laminate.

The membrane may have a water contact angle of about 0° to about 10°. For example, the membrane may have a water contact angle of about 0° to about 5°, about 0° to about 4°, about 0° to about 3°, about 0° to about 2°, about 0° to about 1°, or about 0°. For example, the membrane may have a water contact angle of 0°.

The membrane may have a water permeance of about 100 L·m⁻²·h⁻¹·bar⁻¹ to about 2000 L·m⁻²·h⁻¹·bar⁻¹. For example, the permeance may be about 1000 L·m⁻²·h⁻¹·bar⁻¹ to about 1300 Lm⁻²·h⁻¹·bar⁻¹, about 1100 L·m⁻²·h⁻¹·bar⁻¹ to about 1300 L·m⁻²·h⁻¹·bar⁻¹, 1200 L·m⁻²·h⁻¹·bar⁻¹ to about 1300 L·m⁻²·h⁻¹·bar⁻¹, 1000 L·m⁻²·h⁻¹·bar⁻¹ to about 1200 L·m⁻²·h⁻¹·bar⁻¹, about 1000 L·m⁻²·h⁻¹·bar⁻¹ to about 1100 L·m⁻²·h⁻¹·bar⁻¹, or any value or subrange therebetween.

The membrane may have a flux recovery of about 80% to about 99.9%. The flux recovery may be the amount of water permeance following fouling and backwashing the membrane as compared to the initial water permeance of the membrane. For example, the flux recovery may be about 80% to about 99.9%, about 85% to about 99.9%, about 90% to about 99.9%, about 91% to about 99.9%, about 92% to about 99.9%, about 93% to about 99.9%, about 94% to about 99.9%, about 95% to about 99.9%, about 96% to about 99.9%, about 97% to about 99.9%, about 98% to about 99.9%, about 99% to about 99.9%, or any value or subrange therebetween.

In another aspect, a method of filtering an aqueous liquid includes passing the aqueous liquid through a membrane at a permeance; backwashing the membrane; and after backwashing, passing the aqueous liquid through the membrane again with a flux recovery.

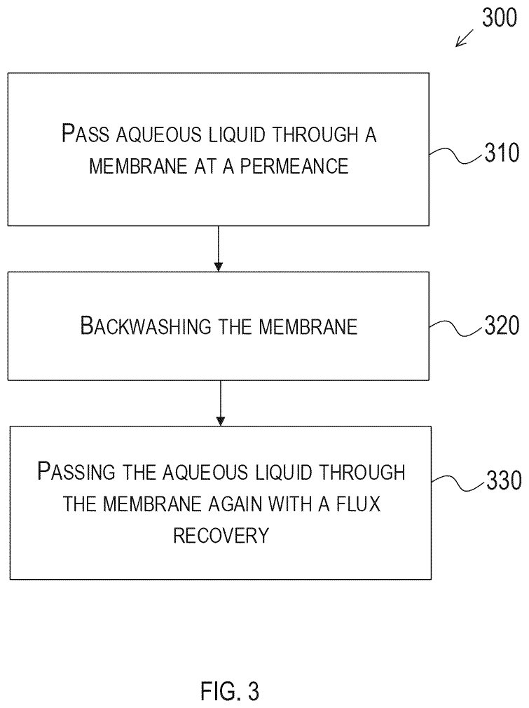

FIG. 3 is a flow diagram of a method 300 of filtering an aqueous liquid using a modified PVDF membrane. The modified PVDF membrane may be any of those disclosed herein. The method 300 may include the step 310 of passing an aqueous liquid through the modified PVDF membrane at a permeance.

The permeance may be about 100 L·m⁻²·h⁻¹·bar⁻¹ to about 2000 L·m⁻²·h⁻¹·bar⁻¹. For example, the permeance may be about 1000 L·m⁻²·h⁻¹·bar⁻¹ to about 1300 L·m⁻²·h⁻¹·bar⁻¹, about 1100 L·m⁻²·h⁻¹·bar⁻¹ to about 1300 L·m⁻²·h⁻¹·bar⁻¹, 1200 L·m⁻²·h⁻¹·bar⁻¹ to about 1300 L·m⁻²·h⁻¹·bar⁻¹, 1000 L·m⁻²·h⁻¹·bar⁻¹ to about 1200 L·m⁻²·h⁻¹·bar⁻¹, about 1000 L·m⁻²·h⁻¹·bar⁻¹ to about 1100 L·m⁻²·h⁻¹·bar⁻¹, or any value or subrange therebetween.

Passing the aqueous liquid through the membrane may include flowing the aqueous liquid in a first direction. Passing the aqueous liquid through the membrane may be conducted at a transmembrane pressure of about 0.1 bar to about 5 bar (e.g., about 0.1 bar to about 2 bar, about 0.1 bar to about 1 bar, about 0.2 bar to about 1 bar, 0.4 bar to about 1 bar, 0.6 bar to about 1 bar, about 0.8 bar, or any value or subrange therebetween).

The method 300 may include the step 320 of backwashing the membrane. Step 320 may be conducted at a predetermined operation time or when the permeance decreases a predetermined amount (e.g., due to membrane fouling). The predetermined permeance decrease may be about 5% to about 90% of the initial membrane permeance (e.g., about 10% to about 80%, about 30% to about 70%, about 40% to about 60%, about 50%, or any value or subrange therebetween).

Backwashing the membrane may include flowing aqueous liquid in a second direction that this opposite the first direction. Backwashing may remove foulants from the membrane to reduce or remove membrane fouling. Backwashing the aqueous liquid through the membrane may be conducted at a transmembrane pressure of about 0.1 bar to about 5 bar (e.g., about 0.1 bar to about 2 bar, about 0.1 bar to about 1 bar, about 0.2 bar to about 1 bar, 0.4 bar to about 1 bar, 0.6 bar to about 1 bar, about 0.8 bar, or any value or subrange therebetween).

The method 300 may include the step 330 of passing the aqueous liquid through the membrane after backwashing with a flux recovery. The membrane may have a flux recovery of about 80% to about 99.9%. The flux recovery may be the amount of water permeance following fouling and backwashing the membrane as compared to the initial water permeance of the membrane. For example, the flux recovery may be about 80% to about 99.9%, about 85% to about 99.9%, about 90% to about 99.9%, about 91% to about 99.9%, about 92% to about 99.9%, about 93% to about 99.9%, about 94% to about 99.9%, about 95% to about 99.9%, about 96% to about 99.9%, about 97% to about 99.9%, about 98% to about 99.9%, about 99% to about 99.9%, or any value or subrange therebetween.

The present invention, thus generally described, will be understood more readily by reference to the following examples, which are provided by way of illustration and are not intended to be limiting of the present invention.

### EXAMPLES

### Example 1: Fabrication and Characterization of Modified Membranes

In water treatment, membranes may encounter a complex feed mixture containing natural organic matter (NOMs), and may be burdened with extreme fouling. PVDF, although an excellent choice for such membranes, are extremely susceptible to fouling due to their hydrophobicity. To overcome PVDF's lack of functional groups for ALD, a modification step prior to ALD was added to impart well dispersed chemical moieties that promote ALD nucleation. This allowed fabrication of super-hydrophilic membranes using as few as one ALD cycle.

Materials. Polyvinylidene Fluoride (PVDF) membranes (Durapore, hydrophobic, nominal pore size: 220 nm) were purchased from Millipore Sigma, USA. Sodium hydroxide (NaOH, 5 N) was purchased from Fisher Scientific, USA. Ethanol (C₂H₅OH) was purchased from Fisher Scientific, USA. Humic acid (HA) was used as model foulant and was purchased from Sigma-Aldrich, USA. Ultrapure water used for filtration experiments and for ALD was purchased from Millipore Sigma, USA. Trimethyl alumina (TMA), diethyl zinc (DEZ) and titanium tetrachloride (TiCl₄) metal precursors, were purchased from Sigma-Aldrich and used as received. Oxygen (O₂) was purchased from Airgas, USA. Nitrogen (N₂) used in the ALD reactor was supplied from in-house facility provided by Argonne National Lab, UChicago LCC.

Membrane pretreatment. Four different techniques were used to pretreat the PVDF membranes prior to ALD. In one, in-situ ozone (O₃) was used to introduce hydroxyl groups on to the PVDF membrane. The ozone pretreatment was done for a predetermined period of time at 80° C. in the ALD reactor. The ALD reactor was a custom built, hot walled, viscus flow atomic layer deposition reactor. The ozone gas was generated using an Ozone Engineering L11 corona discharge ozone generator, fed with ultrapure O₂ at 200 mL min⁻¹. This unit generated a mixture of about 10% O₃ in O₂. The generated ozone was introduced into the ALD reactor kept under about 1 Torr base pressure, at 200 mL min⁻¹ flow of N₂. In another pretreatment technique, the pristine PVDF membranes were pretreated with a combination of ultraviolet light (UV) and ozone (UV-ozone) at room temperature. A Jetlight Company, Inc. Model 30 UV-ozone cleaner was used to incorporate oxygen groups into the PVDF membranes, where the membranes were kept in the reactor for a predetermined period of time. In another pretreatment technique, alkali pretreatment was used to impart oxygen containing groups. The membranes were soaked in 190 proof ethanol (C₂H₅OH) and then submerged into a 5 N NaOH solution, kept at 75° C. in an air oven. After a predetermined period of NaOH pretreatment, the membranes were washed thoroughly with deionized water to remove excess NaOH from the surface. The membranes were dried in the air oven at 75° C. for a few minutes before storage. The O₂ plasma modification was carried out in a PDC 32 g (115 V) basic plasma cleaner from Harrick Plasma, USA under 300 m Torr pressure with constant flow of industrial grade air (21% O₂) operating under high power.

Atomic Layer Deposition. All ALD was performed in a home-built, hot-walled, viscous flow stainless steel reactor with an internal diameter of 5 cm, with temperature controlled using heating tapes. The metal oxide depositions were performed at 80° C. and under high purity N₂ sweep gas, at a pressure of about 1 Torr. Pristine and modified PVDF membranes were fixed with silicone double sided adhesive tape on a metal frame and placed inside the ALD reactor and equilibrated for 20 min prior to deposition. All ALD precursors were maintained at room temperature. Deionized H₂O was used as the co-reactant for metal oxide depositions. Alternating pulses of the metal precursor and water co-reactant were used for performing the metal oxide deposition. An ALD timing sequence of 5-60-5-60 seconds was employed for all metal oxide deposition—where 5 seconds of metal precursor (TMA) dose (or precursor exposure time) was followed by 60 seconds of precursor purge, then 5 seconds of co-reactant (H₂O) dose, followed by 60 seconds of purge. To deposit other metal oxides, diethyl zinc (DEZ) for ZnO and titanium (IV) chloride (TiCl₄) for TiO₂ were used in place of TMA. Characteristic atomic layer growth was confirmed on a silicon wafer with a native silicon oxide (SiO₂) layer.

X-ray photoelectron spectroscopy. To determine the chemical composition and chemical state, X-ray photoelectron spectroscopy (XPS) was used. XPS was conducted on a Thermo Fisher k-Alpha⁺ having micro-focused monochromatic Al Kα (1487 eV) X-ray source and a spot size of 400 μm. Survey scans used a pass energy of 200.0 eV and a step size of 1.000 eV. Measurements were averaged over 7 scans. High resolution scans used a pass energy of 50.0 eV and a step size of 0.100 eV. Measurements were averaged over 5 scans. To understand the concentration of elements across the thickness of the PVDF films and membranes, XPS depth profiling was conducted via etching with argon sputtering, the energy of which was calibrated to medium power, corresponding to 0.51 nm s⁻¹ of etching of Ta₂O₅. There was a 1 second delay between each etch cycle. The XPS spectra were referenced to the C1s peak at 283.8 eV and were processed using Thermo Fisher Avantage software (v. 5.977, Build 06436). Deconvolution was performed by Powell peak fitting with mixed Gaussian-Lorentzian line shapes and a smart background.

Water Contact Angle. To measure the hydrophilicity of the membranes, water contact angle was measured using a drop shape analyzer (DSA 25E from KRÜSS) in sessile drop mode. Unless otherwise specified, measurements were taken 3 seconds after the water was dropped onto the surface. For membranes with water contact angles of about 0°, measurements were taken instantaneously (at less than about 0.5 seconds). Water contact angles (except for time series studies) were averaged over 3 measurements.

In-situ ellipsometry. A Film Sense in-situ ellipsometer was used to measure the thickness increase of the Al₂O₃ layer during ALD on native SiO₂, spin coated PVDF films, and pretreated spin coated PVDF.

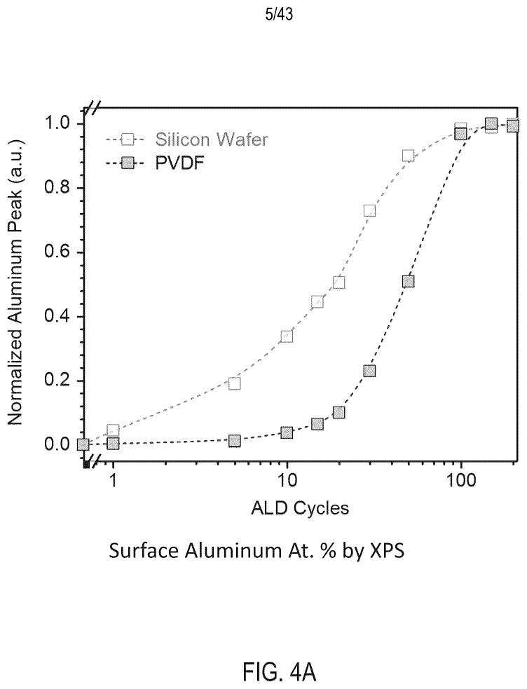

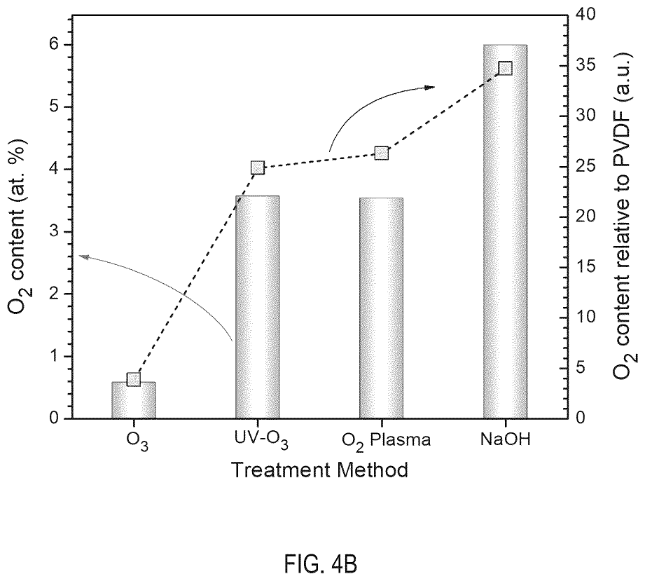

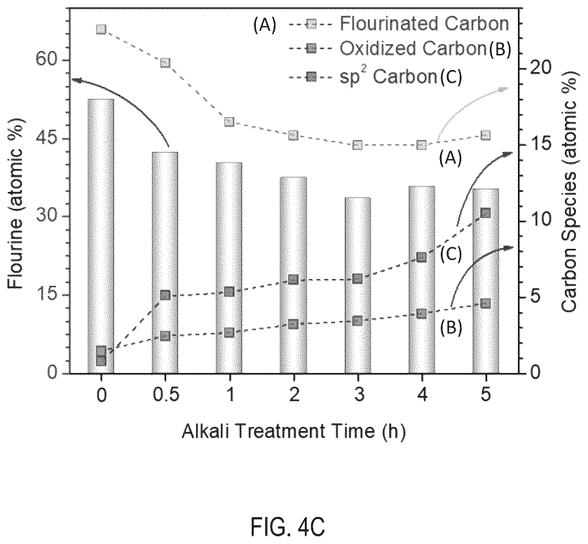

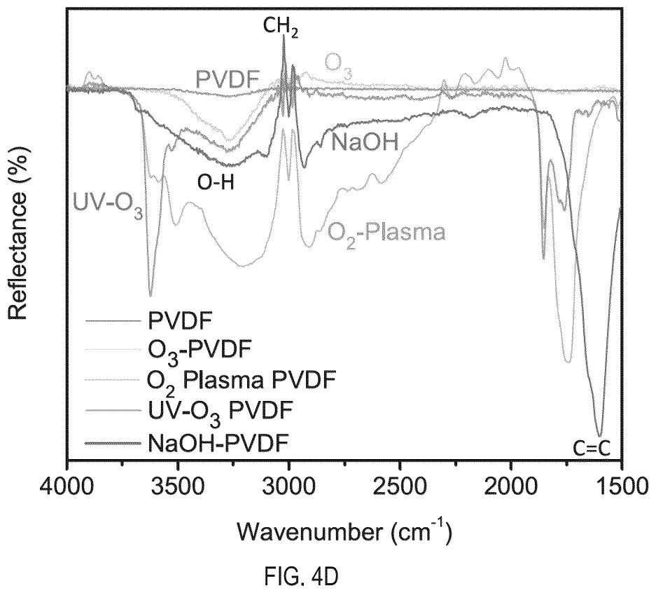

Results. FIGS. 4A-4C provide characterization of delayed growth of atomic layer deposition (ALD) and PVDF pretreatment. FIG. 4A is a graph of normalized peak area observed from X-ray photoelectron spectroscopy (XPS) for aluminum oxide growth via ALD on a silicon wafer as compared to growth on PVDF. Normalization was with respect to each of the saturated peak area at 150 cycles and greater. Characterization of ALD of aluminum oxide (Al₂O₃) deposited using trimethyl alumina (TMA) and water (H₂O) on pristine PVDF indicated delayed growth, as compared to the standard growth on a silicon wafer with native silicon oxide (SiO₂).

The normalized aluminum peak area from XPS indicated Al₂O₃ growth on the pristine PVDF membrane, with a slower growth rate of aluminum oxide on the pristine PVDF membrane with increasing ALD cycles compared to growth on the native SiO₂ on silicon. A difference between surface aluminum content between PVDF and silicon wafer was observed, especially between 10 cycles and 60 cycles. Without being bound by any theory, this may be due to the lack of functional moieties required for ALD growth on a pristine PVDF compared to silicon wafer. The delay in linear thickness increase of the Al₂O₃ was observed by in-situ ellipsometry measurement on PVDF coated silicon wafer as compared to native SiO₂. Without being bound by any theory, this may indicate delayed growth of metal oxide on PVDF due to lack of functional moieties.

To overcome nucleation delay of ALD on PVDF, PVDF was pretreated to impart oxygen-containing groups. Without being bound by any theory, the functional moieties may accelerate ALD nucleation and growth on the membrane to realize a thin and continuous metal oxide film deposited on the membrane with few cycles of ALD that is useful as an anti-fouling membrane. Four different methods of pretreating PVDF were explored—ozone (O₃) pretreatment from a remote corona discharge at 80° C.; combined ultraviolet (UV) light exposure and O₃ pretreatment (UV-O₃) at room temperature; oxygen (O₂) plasma pretreatment at room temperature; and hydroxide (sodium hydroxide, NaOH) pretreatment at 75° C.

FIG. 4B is a graph of oxygen content (left axis) of the pretreated PVDF membranes after 5 hours of pretreatment with UV-O₃, O₃, or NaOH, or after 1 hour of O₂ plasma, and the oxygen peak area relative to PVDF (right axis) after the pretreatment as measured by XPS. After the pretreatment, PVDF was observed to have a higher oxygen content, with significantly higher (25-35 times) oxygen content after 5 hours of UV-O₃ or NaOH pretreatment. The increase in oxygen content in PVDF with pretreatment time was measured for each of the methods. Among the four different modifications, UV-O₃ and NaOH pretreatment generated the higher concentration of oxygenated functional groups. O₂ plasma was also effective, but it made membranes brittle, rendering them unusable for filtration under pressure. NaOH pretreatment imparted the higher concentration of oxygenated groups and was used for further membrane modification via ALD. Compared to pristine PVDF, significant changes were observed in the deconvoluted detailed C1s region of the PVDF after pretreatment.

FIG. 4C is a graph of fluorine content (left axis) and carbon content (right axis) as measured by XPS of PVDF pretreated with NaOH for different amounts of time. Results indicate NaOH pretreatment of PVDF resulted in de-fluorination and sp² carbon formation, as indicated by the loss of total fluorine (left axis) and decrease in C—F bonds and increase in total sp² carbon (right axis) with pretreatment time. NaOH pretreatment also increased the oxygen content in PVDF. After NaOH pretreatment, the atomic percentage of fluorinated carbon (C—F) decreased along with an increase in sp² and oxygenated carbon groups with reaction time (by 30.8% and about 1260% respectively after 5 hours). An increase in oxygenated carbon groups was also observed following the UV-O₃ and O₂ plasma pretreatments, but less than 1% change in C—F bonds was observed under these conditions.

FTIR spectroscopy data in FIG. 4D further indicated the disappearance of twin CH₂ peaks at ~3,000 cm⁻¹, and formation of a peak at 1,600 cm⁻¹ associated with C—C formation and the broad-OH peaks at 3,500 cm⁻¹. Compared to pristine PVDF, scanning electron micrographs (SEM) did not show any morphological changes in the PVDF membranes after various treatments.

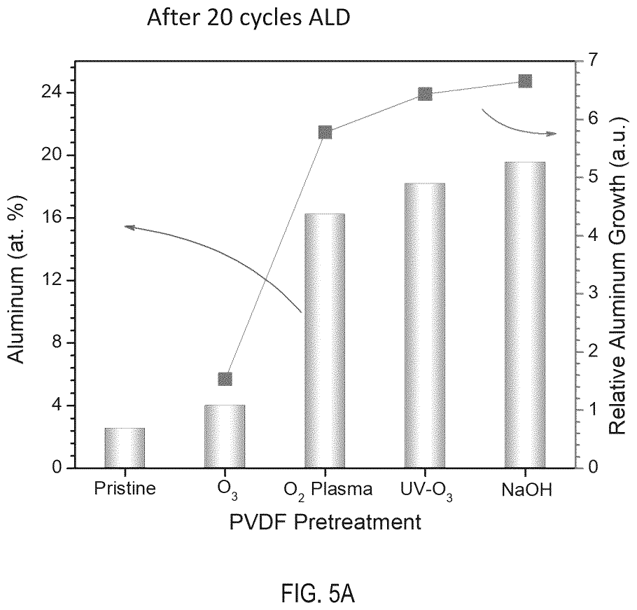

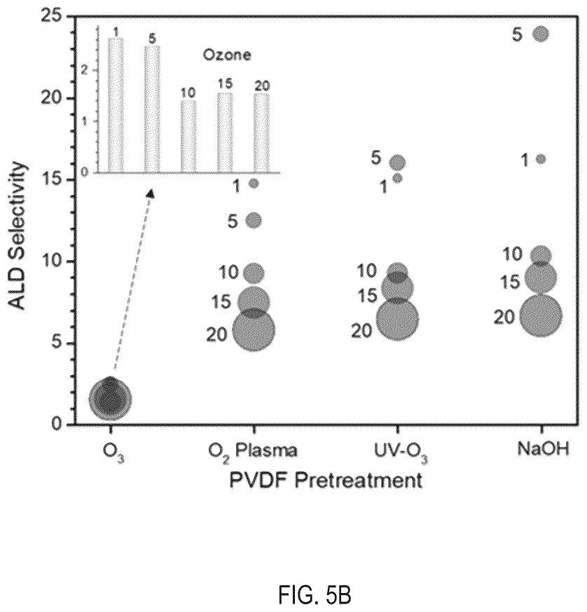

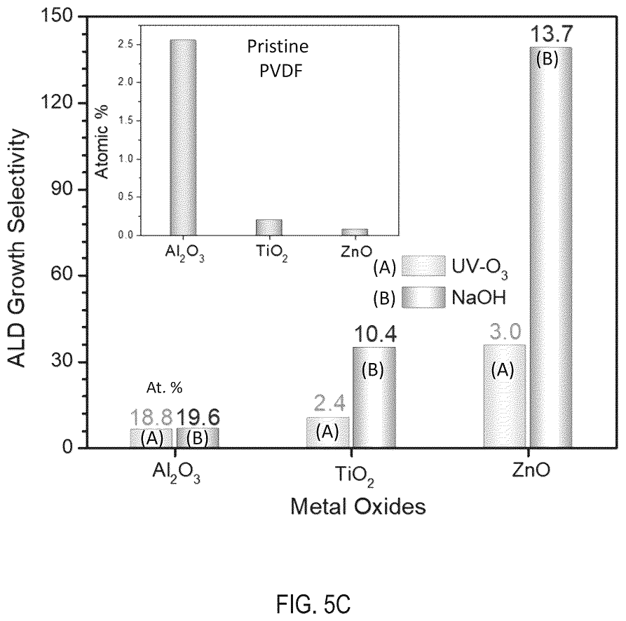

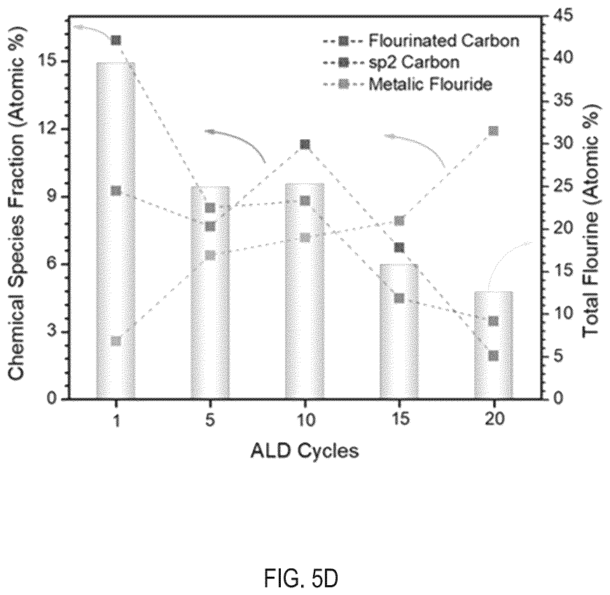

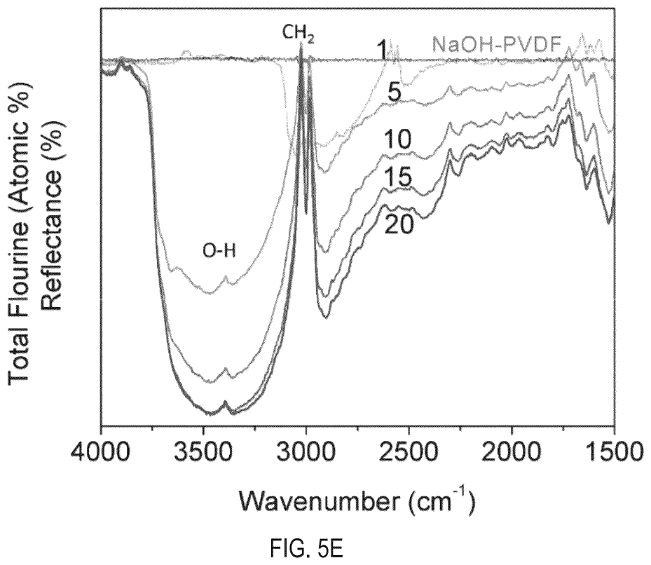

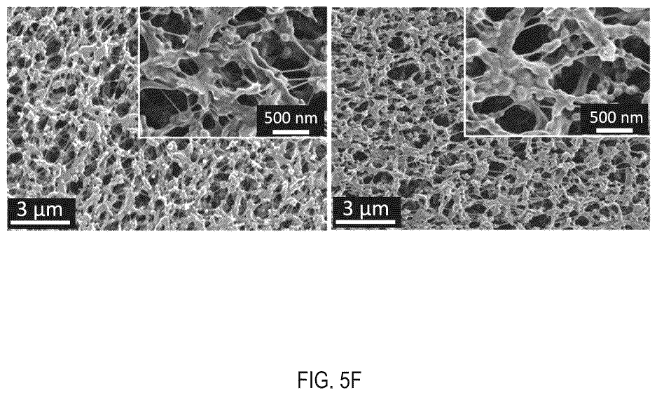

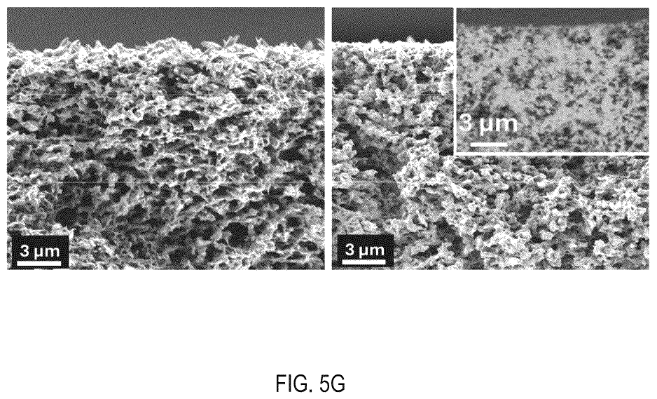

FIGS. 5A-5D provide characterization via XPS of ALD modified pretreated PVDF membranes. FIG. 5A is a graph of the surface atomic percent (at %) of aluminum in aluminum oxide as measured by XPS after 20 ALD Al₂O₃ cycles following different pretreatments (pristine, 5 hours UV-O₃, 5 hours O₃, 5 hours NaOH, or 0.5 hours O₂ plasma). The incorporation of oxygen containing groups on PVDF via pretreatment with UV-O₃, O₂ plasma, or NaOH accelerated the nucleation of ALD films as compared to ALD on pristine PVDF. The aluminum content on the surface of the membranes after 20 ALD cycles was measured with XPS. Compared to pristine PVDF, the UV-O₃, O₂ plasma, and NaOH pretreated membranes had about 7 times higher aluminum content, whereas the O₃-pretreated membrane had only about 1.5 times higher aluminum content. The atomic percentage of aluminum deposited by ALD was highly correlated (R₂≥0.95) to the oxygen content in the PVDF following pretreatment to impart oxygen-containing groups.

FIG. 5B is a graph of selectivity of Al₂O₃ ALD using TMA as the metal precursor and H₂O as the co-reactant (surface Al at % compared to pristine PVDF) for different modified PVDF surfaces. Larger bubbles indicate greater numbers of ALD cycles (noted beside each data point). The inset shows the at % of aluminum after different numbers of ALD Al₂O₃ cycles. XPS measurements were conducted at different depths of Al₂O₃ deposited on a spin coated PVDF film (about 25 nm thick) on a silicon wafer. The Al₂O₃ deposited on the surface without significant penetration into the bulk polymer. The ratio of surface metal concentration after ALD between pristine and modified PVDF was an indicator of growth selectivity. The growth selectivity between Al₂O₃ on modified PVDF and pristine PVDF varied depending on the modification method and number of ALD cycles, with higher selectivity of about 24 achieved after 5 ALD cycles on NaOH-pretreated PVDF. The selectivity dropped with increasing number of ALD cycles. Without being bound by any theory, this may be due to later ALD cycles or Al₂O₃ growing on Al₂O₃ rather than PVDF.

FIG. 5C is a graph of growth selectivity for 20 cycles of ALD growth for 3 different metal oxides-Al₂O₃, TiO₂ and ZnO-on two pretreated PVDF surfaces (after NaOH pretreatment or UV-O₃ pretreatment). The inset provides the respective surface at % of the metals on pristine PVDF membrane. TiO₂ and ZnO ALD were conducted on pristine, UV-O₃ pretreated PVDF surfaces, and NaOH-pretreated PVDF surfaces. Higher selectivity was observed for these metal oxides after 20 ALD cycles. ZnO had the higher deposition selectivity (about 140) on NaOH-pretreated PVDF. Even though post 20 cycles ALD, surface concentration of aluminum was larger among others, ZnO (13.7 at % on NaOH-pretreated PVDF) showed higher surface concentration compared to TiO₂ (10.4 at %) in contrast to their ionization potential values.

FIG. 5D is a graph of changes in the surface chemistry of NaOH-pretreated PVDF with varying numbers of ALD cycles. Growth of ALD Al₂O₃ on NaOH-pretreated PVDF membranes was explored as a function of number of ALD cycles. With increasing number of Al₂O₃ALD cycles, more aluminum was deposited on the NaOH-pretreated PVDF membrane. The abundance of surface hydroxyl groups (e.g., 35.2 at % in native SiO₂) favored faster growth rates in the initial ALD cycles as compared to later ALD cycles. Although the number of oxygenated groups on NaOH-pretreated PVDF was 5.9 times lower than that of native SiO₂, similar ALD growth rates were observed on NaOH-pretreated PVDF as on native SiO₂. Surface functional groups were characterized with increasing numbers of ALD cycles using XPS. A steady decrease in number of C—F bonds (at 291.5 eV in the detailed C1s region) and sp² carbon bonds (at 284.8 eV) were observed with increasing numbers of ALD cycles.

FIG. 5E is a graph of FTIR spectra for NaOH-PVDF after different numbers of Al₂O₃ALD cycles with the spectra of NaOH-PVDF subtracted from them. After the first ALD cycle, the hydroxyl peak observed in FTIR (3500 cm⁻¹) remained unchanged, despite the expected consumption of hydroxyl groups during TMA exposure because they are replenished during the subsequent water exposure. However, in the later cycles, a continuous increase of the hydroxyl peak was seen up to 15 cycles compared to the NaOH-PVDF, beyond which it saturated. The FTIR signals, which reflect bulk properties, showed peaks at about 1600 cm⁻¹ with increasing intensity with ALD cycles, suggesting the formation of C—C bonds. However, this contradicted the XPS result, which showed depletion of the C—C bonds (FIG. 5A). Without being bound by any theory, this discrepancy may arise because the XPS signals are attenuated by the deposited Al₂O₃ layer. Therefore, there is simultaneous de-fluorination and C—C bond formation in NaOH-PVDF during Al₂O₃ALD. Without being bound by any theory these results indicate TMA primarily reacts with hydroxyl groups in NaOH-PVDF, unlike in pristine PVDF where it targets C—F groups.

FIG. 5F is plan-view SEM images of surface morphology—the pristine PVDF membrane (left) and 20 ALD cycles-modified NaOH-PVDF membrane (right). The inset shows membrane pores in higher magnification in each case. Plan view scanning electron micrographs (SEM) in FIG. 5F revealed no significant changes in membrane surface morphology or pore size/structure following 20 ALD Al₂O₃ cycles post-alkali treatment (right) when compared to the pristine PVDF membrane (left). Additional SEM images following 1, 5, 10, 15, and 20 ALD Al₂O₃ cycles were also characterized. These observations suggest that the modification process should not affect separation or permeation properties that are related to pristine membrane's pore size and structure.

FIG. 5G is cross-sectional SEM images (pristine PVDF on left, 20 ALD cycles-modified NaOH-PVDF on right) show that the internal pore structure is unchanged and EDS elemental map (inset on right) shows a uniform aluminum distribution. The cross-sectional SEM images further indicate that the internal pore structure remained intact after modification. 20 ALD cycles was used to modify the membranes, which can deposit about 2 nm Al₂O₃ which is two orders of magnitude smaller than membrane pore size; hence ALD cannot affect membrane pore structure. Moreover, cross-sectional EDS measurements of aluminum concentration across the membrane demonstrated that 5 second precursor dose during ALD was sufficient for precursor diffusion and reaction throughout the membrane.

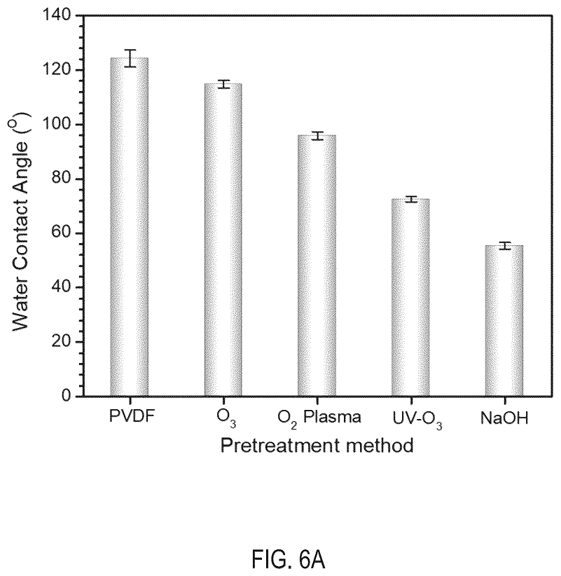

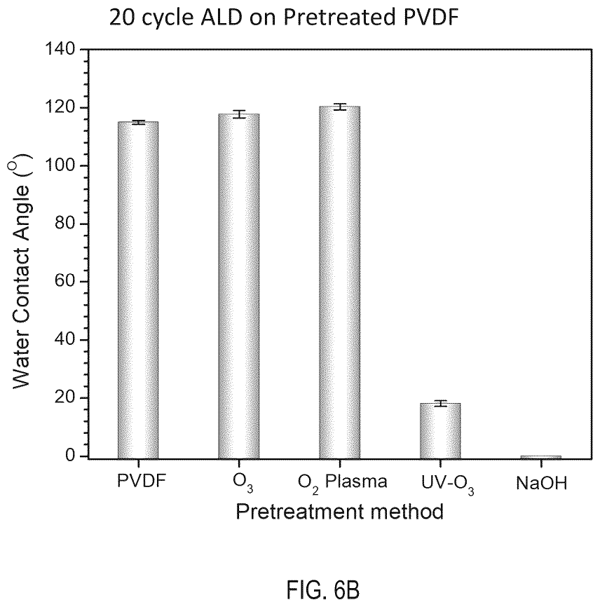

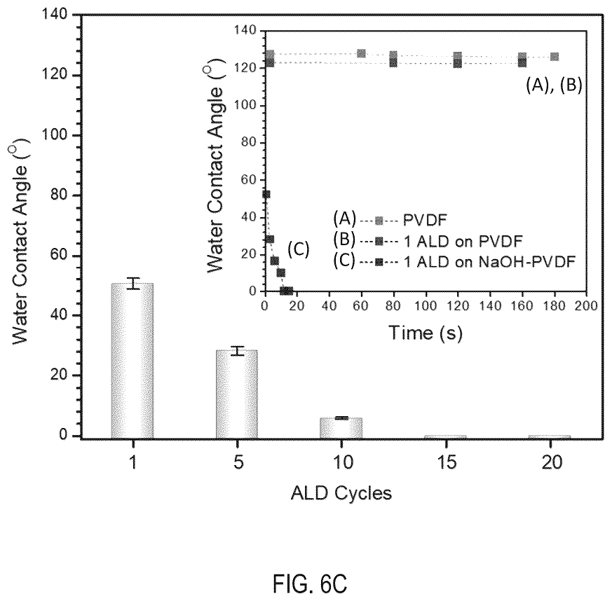

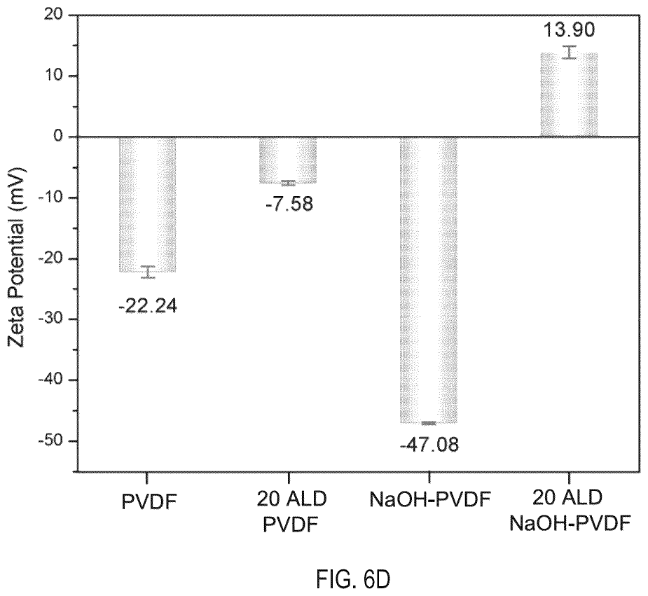

FIGS. 6A-6D provide characterization of wettability and antifouling characteristics of PVDF. The extended Derjaguin-Landau-Verwey-Overbeek theory states that among other factors, the water contact angle (WCA) and the surface charge may be used to indicate anti-fouling properties of a membrane. WCA measurements were taken after 3 seconds, except for NaOH-PVDF, where the water drop disappeared instantaneously after it touched the surface. FIG. 6A is a graph of sessile drop water contact angle (WCA) for pristine PVDF and PVDF after 5 hours of NaOH, UV-O₃, or O₃ pretreatment or 30 mins of O₂ plasma pretreatment. The pristine PVDF membrane was very hydrophobic in nature, with a WCA of about 130°, meaning the pristine membrane is susceptible to fouling in the presence of organic foulants. After PVDF modification, pretreatment with UV-O₃ or NaOH-PVDF provided a membrane that was slightly hydrophilic. Surprisingly, O₂ plasma did not considerably improve hydrophilicity.

FIG. 6B is a graph of WCA after 20 cycles of Al₂O₃ deposition on pristine and pretreated PVDF. ALD was carried out using TMA and H₂O. After 20 ALD cycles, the UV-O₃ pretreated PVDF and NaOH-pretreated PVDF demonstrated a drastic decrease in WCA, with NaOH-pretreated PVDF exhibiting a WCA of 0° as soon as the water droplet was placed on it. Surprisingly, for O₃-pretreated PVDF and O₂ plasma-pretreated PVDF, WCA slightly increased after 20 Al₂O₃ ALD cycles. UV-O₃-pretreated PVDF showed an increased hydrophobicity (WCA of about) 135° after 1 ALD cycle.

FIG. 6C is a graph of initial WCA for NaOH-pretreated PVDF modified with different numbers of ALD cycles. The inset provides WCA of just 1 cycle ALD reduced to 0° within about 10 seconds of touching the surface, while it remained constant for pristine PVDF, and 1 cycle of ALD on pristine PVDF. For NaOH-pretreated PVDF, WCA was observed to decrease with increasing number of ALD cycles, with water droplets flattening instantly upon touching the surface for NaOH-pretreated PVDF modified with more than 15 ALD cycles of Al₂O₃. The WCA of 1 ALD cycle modified NaOH-PVDF reduced to 0° within 11 seconds of water touching the surface. In contrast, pristine PVDF and 1 cycle ALD modified PVDF demonstrated constant WCA of about 124°, indicating a highly hydrophobic surface. The WCA remained mostly constant up to 200 seconds for membranes where the initial WCA (measured at 3 seconds), was greater than 60°. Surprisingly, no good correlation was observed for metal oxide loading and WCA for O₂-plasma-pretreated PVDF and O₃-pretreated PVDF.

FIG. 6D is a graph of Zeta potential measurements of surface charge of PVDF and NaOH-PVDF membranes before and after 20 Al₂O₃ ALD cycles. Zeta potential measurements of ALD-modified NaOH-treated PVDF membranes (20 cycles) indicated that, prior to ALD modification, the membranes possessed a negative surface charge, rendering them susceptible to fouling. However, the application of 20 Al₂O₃ ALD cycles effectively reversed the surface charge to positive, markedly reducing the membrane's fouling propensity. While a single ALD cycle rendered the NaOH-PVDF membrane hydrophilic, it was insufficient to impart a net positive surface charge.

### Example 2: Antifouling of Modified Membranes

Membranes from Example 1 were tested to evaluate performance using dead-end filtration mode using a stainless-steel filtration cell (Sterlitech; model: HP4750). The weight of the collected permeate was measured using a mass balance (Mettler Toledo; model: LA203E). The weight was converted to volume of permeate collected (V), using the density of permeate (density similar to that of water; 1 g ml⁻¹). The steady-state flux (J) was calculated using the slope of the steady-state portion of the weight vs time (t) series data. The flux (J) through the membrane (area: A, m²) was computed using the following formula:

$$J = \frac{1}{A} ( \frac{dV}{dt} ) \qquad ( 1 )$$

The permeance (P) of the membrane was computed by dividing the flux by the transmembrane pressure (Δp).

The initial pure water permeance (P₁) of the membrane was measured with deionized (DI) water. The transmembrane pressure of the membrane was maintained at about 0.8 bar. A fresh membrane was operated for about 35-40 mins to get compacted and reach steady state flux. After obtaining the pure water permeance, the membrane was subjected to fouling using 100 mg L⁻¹ of NOM solution in DI water, prepared by continuously stirring humic acid in DI water overnight. The fouling experiment was conducted for 3 hours, and initial permeance (P_{F,i}) and final permeance (P_{F,f}) were recorded. After the fouling experiment, the membrane was back washed using DI water at 0.8 bar for 10 mins. After back washing, the pure water permeance though the membrane in the forward direction (P₂) was measured to estimate permeance recovery. The flux/permeance recovery rate (FRR) was calculated using the following equation

$$FRR = \frac{{P}_{2}}{{P}_{1}} \times 100 \qquad ( 2 )$$

The reversible (PD_{R}) and irreversible (PD_{iR}) permeance decline rate was calculated using the following equations:

$$P {D}_{R} = ( \frac{{P}_{2} - {P}_{F , f}}{{P}_{1}} ) \times 100 \qquad ( 3 )$$

$$P {D}_{i R} = ( \frac{{P}_{1} - {P}_{2}}{{P}_{1}} ) \times 100 \qquad ( 4 )$$

The total natural organic matter content of the feed and the permeate was measured using a UV-Visible absorption spectrometer (Agilent, CARY 5000). The rejection (R) of the membrane was calculated using the following equation:

$$R = ( 1 - \frac{{C}_{P}}{{C}_{F}} ) \times 100 \qquad ( 5 )$$

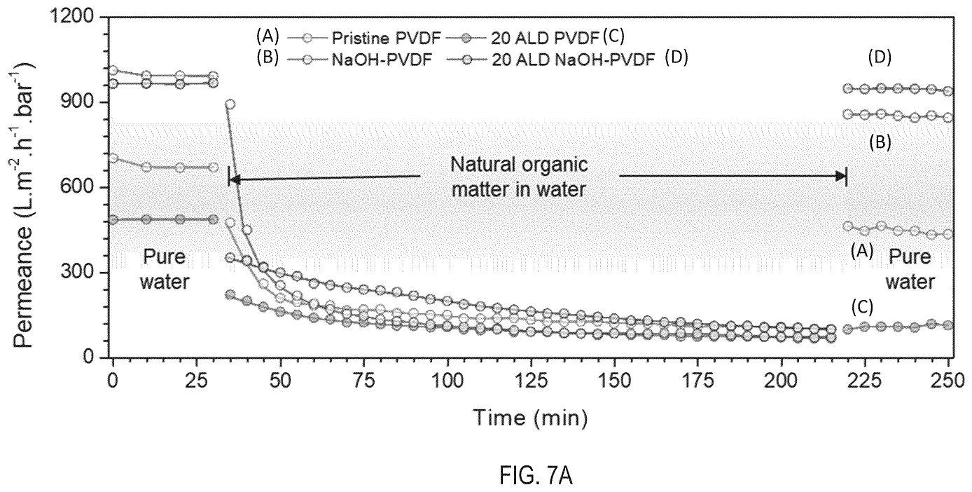

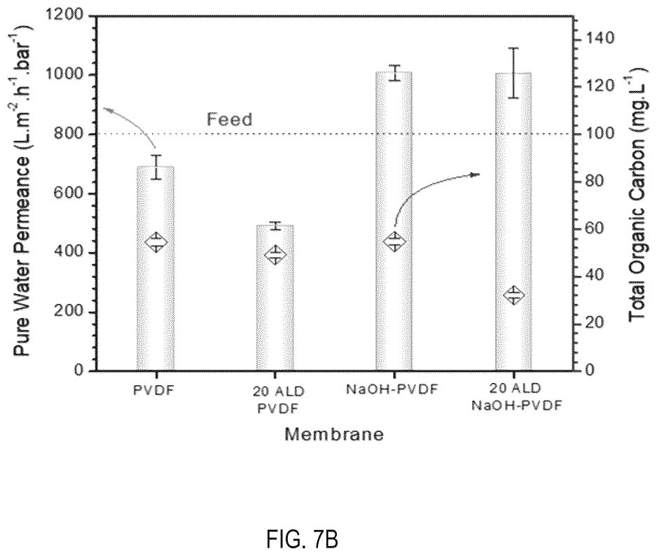

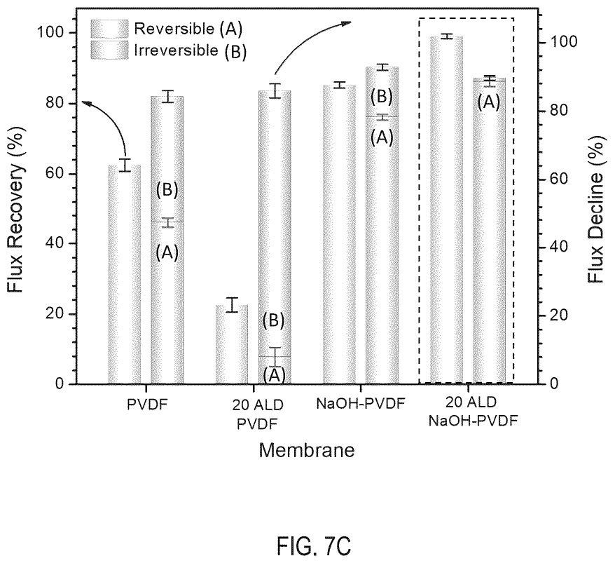

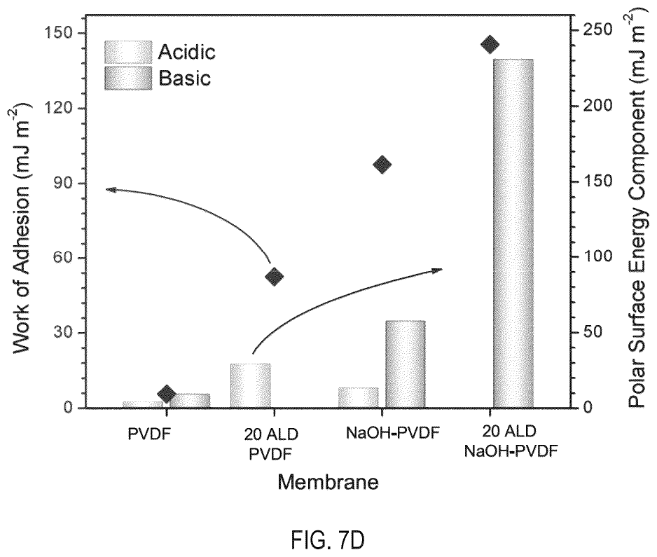

Results. FIGS. 7A-7C provide characterization of antifouling performance of modified PVDF membranes. FIG. 7A is a graph of long-term filtration operation of membranes (pristine PVDF, ALD on PVDF, NaOH-pretreated PVDF, and ALD on NaOH-pretreated PVDF) with pure water as feed, followed by feed containing humic acid solution. Following membrane fouling, these membranes were cleaned, and pure water was used as feed again to understand the permeance recovery through these membranes. FIG. 7B is a graph of pure water permeance through the membranes in FIG. 7A, and the total organic foulant contents in the permeate. FIG. 7C is a graph of parameters describing the antifouling properties of the membrane-flux recovery, and reversible and irreversible decline in flux through the membranes.

Modified membranes and pristine membranes were tested for pure water permeance in a home-built permeation system, following which they were subjected to fouling using humic acid solution, having concentrations higher than that a membrane typically encounters in a treatment facility to accelerate the fouling process. The fouled membranes were then backwashed using water and the membrane's pure water permeance was remeasured. Four membranes were tested to understand the relative improvement in performance—the 20 ALD cycles of Al₂O₃ on NaOH-pretreated PVDF, NaOH-pretreated PVDF, pristine PVDF, and 20 ALD cycles of Al₂O₃ on pristine PVDF. The NaOH modification by itself showed about 50% improvement in initial pure water permeance.

Similar improvements were observed for 20 ALD cycles deposited on NaOH-pretreated PVDF membranes, with initial pure water permeance reaching up to 1100 L·m⁻²·h⁻¹·bar⁻¹. After 20 ALD cycles on pristine PVDF, the membrane's water permeance reduced by 30% compared to pristine PVDF. SEM images showed no distinct change in membrane morphology after NaOH pretreatment or ALD modification. Without being bound by any theory, the differences in permeance may be attributed to membrane surface properties. The initial water permeance was similar for the NaOH-pretreated PVDF membranes modified with different numbers of ALD cycles.

These membranes were subjected to fouling using water containing humic acid for 3 hours and observed significant organic load reduction in the permeate, with 50% more rejection through the membrane pretreated with NaOH and 20 cycles of ALD as compared to pristine PVDF. Pores in all of these membranes were much larger compared to humic acid molecules. NaOH-PVDF pretreated with various ALD cycles showed similar reduction of organic matter in permeate, with about 75% rejection of humic acid.

After 10 mins of backwashing these fouled membranes with water, the water permeance was measured again and the NaOH-pretreated PVDF membrane with the ALD deposited film had the higher flux recovery, with 20 cycles of ALD on pretreated NaOH-PVDF membranes showing about 99% flux recovery. Pristine PVDF and ALD-modified PVDF performed poorly in terms of fouling resistance, demonstrating only 61% and 22% flux recovery. Among these, for the 20 cycles ALD modified NaOH-PVDF membrane, the irreversible flux loss was <1%, whereas PVDF and 20 ALD modified PVDF performed poorly and had 37.0% and 78.9% irreversible flux loss, respectively. The NaOH-PVDF also demonstrated 14.6% irreversible flux loss. For NaOH-pretreated PVDF modified with varying ALD cycles, irreversible flux loss decreased with number of ALD cycles from 17.3±2.15% at 1 ALD cycle to 1.07±0.69% at 20 ALD cycles. Overall, ALD-modified NaOH-pretreated PVDF outperformed other membranes. Without being bound by any theory, this improvement may be attributed to the super-hydrophilicity and surface zeta potential.

Without being bound by any theory, mechanistic understanding of fouling may be obtained from the Chowdhury Van-Oss model. Compared to pristine PVDF, the work of adhesion was 17.2 and 25.7 times higher for NaOH-pretreated PVDF and 20 cycles of ALD on NaOH-modified PVDF, indicating higher energy for the foulant molecule to absorb to the membrane surface for these modified membranes. Without being bound by any theory, this further indicates that the organic matter rejection offered by NaOH-pretreated PVDF and ALD-modified NaOH-pretreated PVDF may be related to repulsion of the organic molecule from the membrane surface, rather than adsorption.

Overall, the ALD-modified NaOH-pretreated PVDF membranes were more resistant to fouling, and had about 50% higher permeance and organic rejection, compared to pristine PVDF. These membranes demonstrated the higher water permeance along with very high flux recovery. Moreover, such superior performance was achieved by only a few ALD cycles, which may be useful for scalability of this post-synthetic modification method.

An alkali-mediated pretreatment step was used to enrich PVDF microfiltration membranes with sufficient nucleation sites for ALD growth. This provided faster deposition of metal oxide on the pretreated PVDF membranes. Alkali nucleation provided the ability for one ALD cycle to have the same antifouling properties as an unmodified PVDF membrane pretreated with greater than 150 ALD cycles. Furthermore, the pretreated PVDF demonstrated excellent ALD deposition selectivity of greater than 135 (for zinc oxide, ZnO), compared to the pristine PVDF membrane. By incorporating such alkali-mediated PVDF modification, greater than 99% flux recovery was achieved, with only about 1% irreversible flux loss during operation. Furthermore, the modified PVDF membrane showed about 50% water permeance increase with about 50% increase in humic acid rejection, compared to pristine PVDF membranes.

FIG. 7D is a graph of theoretically calculated surface energy and work of adhesion for the membranes. A mechanistic understanding of membrane fouling was gained using the Oss-Good-Choudhary model. Contact angles were measured using 3 different solvents (water, ethylene glycol and diiodomethane) to fit the model. Compared to pristine PVDF, the work of adhesion for foulants was 17.2 and 25.7 times greater for NaOH-PVDF and 20 ALD-modified NaOH-PVDF, respectively. This suggests that significantly more energy was used for foulant molecules to absorb onto the modified membrane surface. Consequently, without being bound by any theory, the observed higher rejection of organic matter in NaOH-PVDF and ALD-treated NaOH-PVDF membranes may be possibly due to repulsion. Furthermore, polar surface energy analysis for NaOH-PVDF membranes modified with varying ALD cycles indicated increased resistance to fouling. Overall, ALD-treated NaOH-PVDF membranes demonstrated superior fouling resistance, achieving approximately 50% higher permeance with 50% greater organic rejection compared to pristine PVDF. Moreover, these membranes retained polymer flexibility and were stable at least up to 5.5 bar.

Solvents play a role in many industrial processes, but only a small fraction is recycled, resulting in large volumes of emulsified solvent-water waste. Among these, heavier solvents and oils are particularly challenging to separate from emulsions.

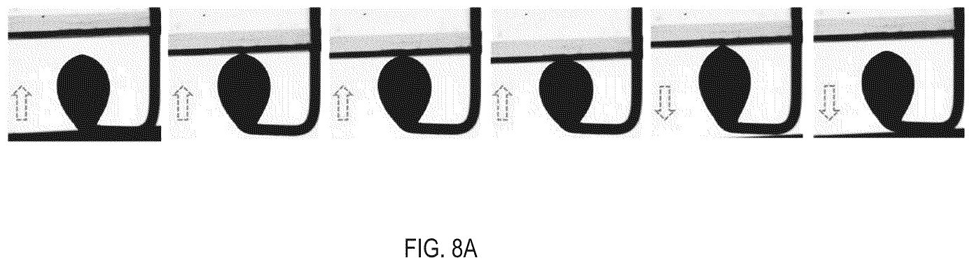

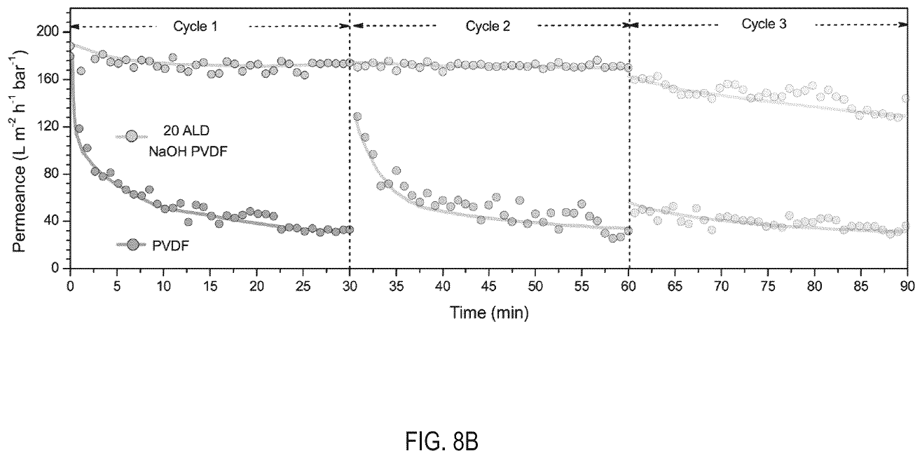

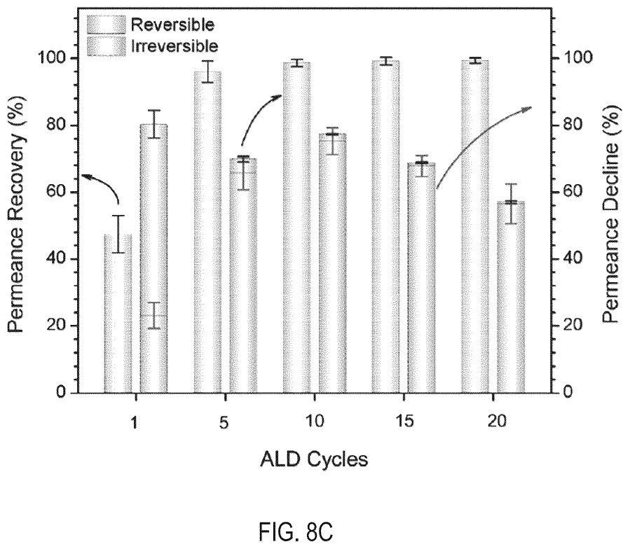

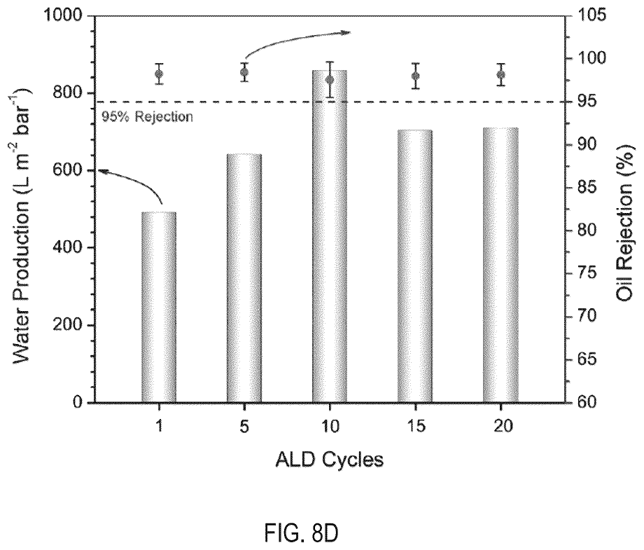

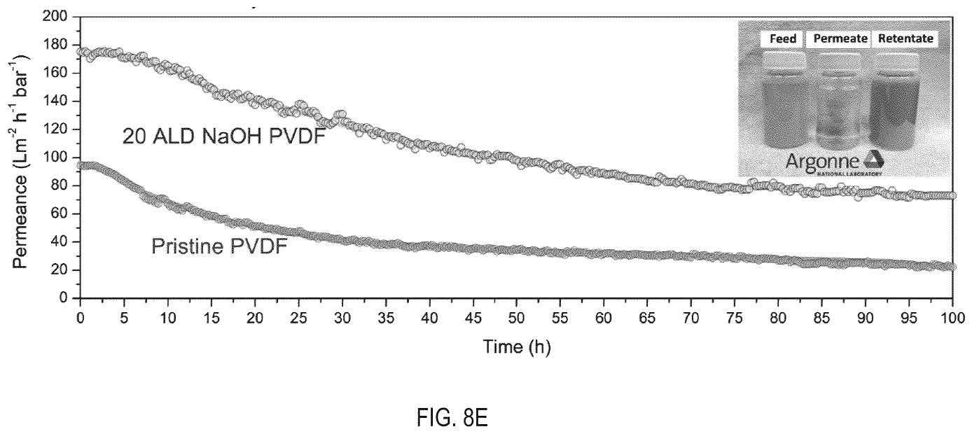

Super-hydrophilicity, strong antifouling nature, and minimal oil adhesion under hydrated conditions (FIG. 8A), these metal oxide surface modified membranes demonstrated extracting water from oil-water emulsions. To evaluate their performance, cyclic filtration tests were conducted with surfactant-stabilized 2% soybean oil-water emulsions using PVDF membranes treated with NaOH and 20 ALD cycles of Al₂O₃. Three consecutive testing cycles were performed with 5-minute backwash intervals between each cycle (FIG. 8B). Almost no decline in permeance was observed in the first two cycles and only about 15% decline was observed in the third cycle. The oil separation efficiency was maintained over 98% in each cycle. Pure water permeance in between each cycle and the membrane achieved almost 100% permeance recovery. In contrast, the pristine PVDF membrane exhibited an immediate decline in permeance, significantly lower permeance recovery, and achieved only around 90% oil rejection. To understand the effect of ALD cycles on the fouling behavior of the surface modified membranes, membranes modified with different numbers of ALD Al₂O₃ cycles were used to perform 1% soyabean oil-water emulsion separation for 4 hours. Except for the NaOH-PVDF modified with 1 ALD cycle, the other ALD modified NaOH-PVDF membranes recovered more than 95% of the initial permeance (FIG. 8C). Similar to fouling with humic acid, the irreversible permeance loss declined with ALD cycles, with less than 1% for 20 ALD modified NaOH PVDF membranes. Pristine PVDF, 20 ALD modified PVDF and NaOH-PVDF membranes were comparison examples, and they demonstrated at least 70% lower permeance recovery and about 100 times higher irreversible loss in permeance. The total water produced during the 4-hour long oil separation was between 700 and 800 L·m⁻² bar⁻¹ for NaOH-PVDF treated with different ALD cycles except for the one treated with only 1 cycle (FIGS. 8D and 8E). Although the 1 ALD treated NaOH-PVDF membrane was hydrophilic, its surface was negatively charged. Compared to this membrane, other ALD treated NaOH-PVDF were capable of repelling oil molecules from the interface due to the strong hydration layers created by metal oxides. This allowed more water molecules to “see” the membrane surface, causing more water to enter the membrane pores. After 4 hours of operation, all ALD treated NaOH-PVDF membranes rejected more than 95% of the oil from the emulsion.

The NaOH-PVDF membranes modified with 20 ALD cycles were subjected to a variety of oil-water emulsions (pump oil, vegetable oil, motor oil and crude oil) and the membranes demonstrated excellent separation efficiency, even with complex crude oil-water emulsions. The membranes demonstrated over 95% oil rejection and over 550 L·m⁻² bar of water production capacity (except for the mechanical vacuum pump oil emulsion) for the various oil-water emulsions in 4 hours, with an impressive permeance recovery of at least 98%. The NaOH-PVDF membranes modified with 20 ALD cycles and the pristine PVDF were subjected to over 100 hours continuous operation to separate water from 1% crude oil-water emulsion. During the 100-hour period, pristine PVDF demonstrated lower initial permeance, and it fouled rapidly within the first 25 hours to achieve a steady permeance of only 21 L·m⁻² h⁻¹ bar⁻¹ which was 4 times lower than its initial permeance. The 20 cycle ALD treated NaOH PVDF membrane, however, lost less permeance and attained a steady state permeance of 73 L·m⁻² h⁻¹ bar⁻¹ after 75 hours, which is only about 2 times lower than its initial permeance and 3.3 times higher than the steady state permeance of pristine PVDF. Unlike pristine, after 100 hours of testing, the surface modified membrane looked as clean as it was before the test. This allowed for over 2.6 times higher water production in the modified membrane compared to the pristine membrane. Even after 100 hours of operation, the modified membrane maintained over 98% crude oil rejection. A 20 hour long term test was performed with 2% vegetable oil to understand adsorption on the membrane. During this study, mass balance across the membrane showed that rejection of the modified membrane was primarily due to repulsion of oil molecules from the metal oxide engineered surface with less than 3% (6.88 mg m⁻² adsorption) absorbed on the membrane surface, compared to 76% for the pristine PVDF. Furthermore, the fabrication process was demonstrated scalable up to 1,200 cm².

### Example 3: Fabrication of Additional Modified Membranes and Single-Step Water Recovery from Stable Crude Oil-In-Water Emulsion Using Modified Membranes

Separating crude oil from water remains a challenge in environmental remediation, especially for surfactant-stabilized emulsions that resist conventional demulsification methods. Here is reported a scalable strategy for achieving near zero-discharge separation of crude oil emulsions using a super hydrophilic membrane. By applying low-temperature ALD of various metal oxides onto activated PVDF membranes, atomically precise surface modified (SM) membranes were prepared that maintained an exceptionally strong hydration layer at the membrane-feed interface, even at high oil loadings. Among the various metal oxides, TiO₂-modified SM membranes exhibited high interfacial water stability, providing sustained dewatering of complex crude oil-water emulsions with >98% separation efficiency and >97% water recovery, compared to only 24.6% water recovery of the pristine membrane. This separation performance surpassed the conventional hydrophilic membranes, representing complete emulsion separation using a single membrane.

Membrane Fabrication. The hydrophobic membrane coupons were wetted with 190 proof ethanol and submerged in 5 N NaOH solution and kept in an air oven at 75° C. for 3 hours, as in Example 1, for alkali activation. After the alkali activation, these membranes were washed thoroughly with deionized (DI) water until the pH of the water was around 7. The membranes were dried in an air oven at 75° C. for 20 minutes before charging them into the ALD reactor. The ALD reactor was a viscus flow, hot walled stainless steel ALD reactor with an internal diameter of 5 cm. All metal oxide depositions were carried out at 80° C. under pressure of about 1 torr at 200 mL min⁻¹ flow of inert nitrogen, unless specified. A dose time of 5 seconds and a purge time of 60 seconds was used for all the metal oxides.

Membrane performance evaluation: Membrane performance was evaluated using a custom build dead ended filtration system, equipped with Sterlitech HP4750 higher pressure testing cell. The liquid (pure water or crude oil emulsion) inside the cell was pressurized using an external nitrogen or argon gas tank. A 1.131 cm² of membrane area (diameter: 12 mm) was used for testing membrane permeance. The permeation tests were done under 0.8-1.0 bar pressure, unless or otherwise stated. The weight of the permeate coming out was measured using a weighing scale, connected to a computer to record time series data. Steady state permeance whenever reported represents permeance values when they are unchanged (<5% change) over a period of 10 minutes. During the crude oil-water separation experiments, the feed above the membrane was subjected to agitation using a rotating magnetic stirrer. Membrane backwashing was performed using either DI water, 10⁻³ N H₂SO₄ (pH=3) or 10⁻³ N NaOH (pH=11) for 15 mins. After backwashing, the membranes were rinsed with water and evaluated for pure water permeance. The permeance (P) through the membrane was calculated using the following equation.

$$P = ( \frac{dV}{dt} ) \times \frac{1}{A Δ P} \qquad ( 6 )$$

where,

$$\frac{dV}{dt}$$

is the instantaneous slope of the volume vs time series data, where the weight was converted into volume using density of water (=1 g ml⁻¹), A and ΔP are the membrane area and transmembrane pressure. Crude oil rejection experiments were done with 3 volume % crude oil in water with ⅛^{th} of crude oil volume surfactant (Tween 80). For long term water recovery, 5 volume % crude oil was used with same concentration of Tween 80. The rejection of crude oil was assessed using a UV-Visible spectrophotometer. The oil concentration was measured against pure water containing Tween 80 as the reference. The crude oil rejection (R) was calculated using the following equation.

$$R = ( \frac{{C}_{f} - {C}_{p}}{{C}_{f}} ) \times 100 \qquad ( 7 )$$

Where C_{f} and Cₚ are the concentration of crude oil in feed and permeate, respectively. Another aspect of oil-water separation is the performance recovery of the membrane after the separation. The three main parameters that judge the membrane's performance recovery are: permeate recovery rate (PRR), reversible (PD_{R}) and irreversible (PD_{iR}) fouling. The permeate recovery rate is estimated by using the ratio of pure water permeance through the membrane before and after fouling (P₁ and P₂ respectively) and is given as

$$P R R = \frac{{P}_{2}}{{P}_{1}} \times 100 \qquad ( 8 )$$

The reversible and irreversible permeance decline rate were calculated using the equations in Example 1, where final permeance (P_{F,f}) were recorded after 2 hours of crude oil emulsion separation experiments.

Molecular dynamic simulation: Molecular Dynamics (MD) simulations were performed to examine the wettability of various metal oxide surfaces in presence of water-oil mixtures. LAMMPS was used for conducting the simulations. Each metal oxide and water-oil system was modeled within a 4 nm×4 nm×4 nm block—where a block of water molecules was placed interspersed with oil molecules above an oxide slab. Oil representative molecules (cyclohexane and octane) were modelled using the TraPPE-UA force-field parameters whereas SPC/E model was used for water. Further, available force-filed parameters were utilized for metals oxides—ZnO, SnO₂, TiO₂, and Al₂O₃. Interatomic interactions were computed using Lennard-Jones and Coulombic potentials. A typical MD simulation consisted of equilibration runs for 1 nanosecond (ns) within an isothermal-isobaric ensemble at temperature=298.15 K and pressure of 1 bar. Results and analysis were derived from a further production run of 0.5 ns using the equilibrated systems.

Results and Discussion. PVDF membranes extremely prone to fouling and post fabrication treatment of these membrane is used to improve hydrophilicity to extend their lifespan for crude oil emulsion separation. Hydrophobic PVDF membranes having 220 nm mean pore size were wetted with ethanol to ensure complete submergence in the alkali solution. These membranes were then treated in 5 N sodium hydroxide (NaOH) solution for 3 hours at 75° C. This alkali activation lead to an about 47-fold increase in oxygen containing functional groups on PVDF which provided nucleation sites for ALD growth. As observed from the X-ray photoelectron spectroscopy (XPS) and Fourier transform infrared spectroscopy (FTIR) analysis, the alkali activation introduced oxygenated groups on PVDF. FTIR further showed an increase in hydroxyl groups and sp² carbon, post alkali activation. This was accompanied by 32.06% loss of surface fluorine groups. Based on these observations, the alkali activation may form C═C bonds and hydroxyl (—OH) groups, due to breakage of C—F bonds. As seen in the SEM micrographs, no significant change in the membrane morphology was observed after the alkali activation process, except that the membrane surface became rougher, which may have increased hydrophilicity.

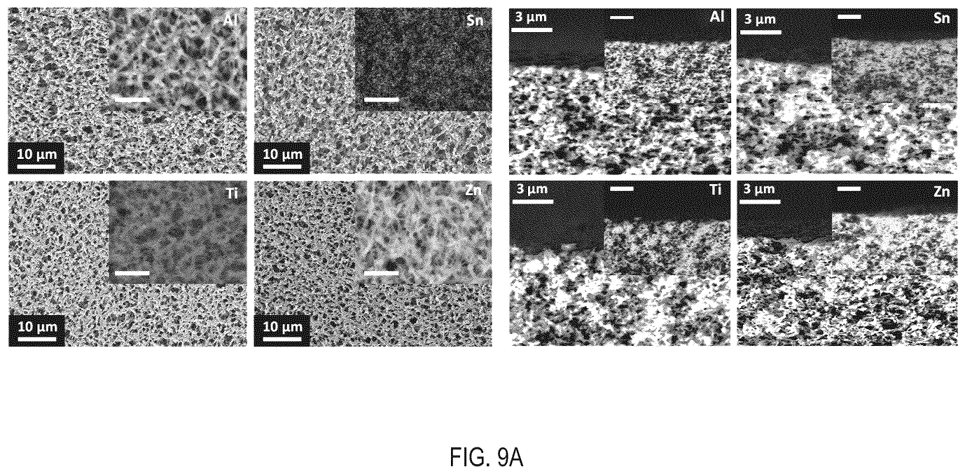

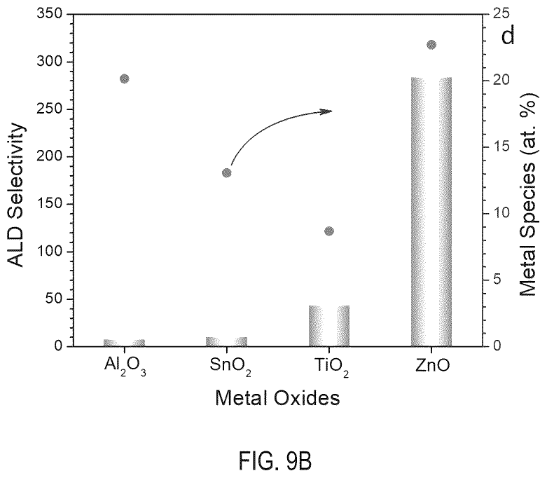

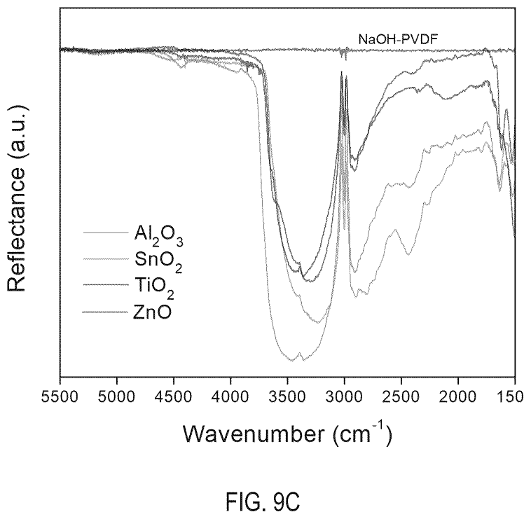

Post alkali activation, PVDF membranes were coated with metal oxides using ALD. ALD was performed at 80° C. in a hot walled, viscous flow reactor and deposited different metal oxides using 20 ALD cycles with 5 second precursor dose and 60 second N₂ purge to ensure sufficient time for the precursors to diffuse into the entire porous structure of the membrane. Layer-by-layer growth of ALD at 80° C. was indicated by in situ quartz crystal microbalance (QCM) measurements. Precursor dose time greater than 5 seconds was sufficient for depositing metal oxides within the pores throughout the thickness of the membrane. The alkali-activated PVDF membranes were modified with 20 ALD cycles to deposit one of four different metal oxides, fabricating metal oxide surface modified PVDF membranes (M-SM PVDF; M=Al, Ti, Sn or Zn). The 20 cycles of these ALD coatings only deposited less than 3 nm of metal oxide layers, as measured via ellipsometry on witness silicon coupons placed in the reactor during the ALD. This thin metal oxide layer was insufficient to cause any change in morphology of the membrane. Metal oxides were incorporated on the activated membranes as evidenced by energy dispersive spectroscopy (EDS) scans. However, no differences in the membrane surface morphology and surface pore structure were observed between the M-SM PVDF membranes compared to the alkali activated PVDF membrane (FIGS. 9A and 9B). Alkali-activated and ALD-coated PVDF membranes maintained similar pore structure/size relative to the pristine membrane, Conformal incorporation of metal oxide throughout the membrane surface and cross section was observed via EDS scans (FIGS. 9A and 9B), indicating uniform surface functionalization on the surface and within the pores. In the case of ALD on pristine PVDF membrane, the amount of metal oxide deposited via ALD was lower due to lack of nucleation sites. Hence the ALD modified PVDF membrane showed no change in the membrane morphology compared to pristine PVDF. However, even with such low amount of metal oxide deposition, the distribution of metal oxides remained fairly uniform. This indicated the uniformity of ALD in achieving surface functionalization, with little change to pore structure of ultra and microfiltration membranes.

When metal oxides were grown via ALD on the non-activated pristine PVDF membranes, the total metal oxide concentration on the membrane surface was lower, as measured by XPS. This non-growth behavior on PVDF helped achieve ALD selectivity (ratio of atomic percentage of metal oxide deposited on the membrane) between the activated and non-activated PVDF membranes (FIG. 9C). ZnO selectivity was as high as 280, even after 20 cycles ALD. TiO₂ selectivity was moderate at about 50 while for SnO₂ and Al₂O₃, the selectivity was lower and was around 10. The metal oxide percentage on the activated PVDF membranes, as determined by XPS was close to the metal oxide at. % that was deposited on a native-SiO₂ on a witness silicon wafer placed in the ALD reactor during membrane modification. In contrast, metal oxides deposited on pristine PVDF for the same number of cycles were low.

FTIR and XPS spectroscopy were used to characterize metal oxide growth on the alkali-activated PVDF. FTIR diffused reflectance spectrographs, taken using alkali-activated PVDF as background (FIG. 9C) showed incorporation of hydroxyl groups (about 3500 cm⁻¹), from hydroxylation of surface metal oxides. The strength of peaks at 3500 cm⁻¹ depended on the type of metal oxide rather than its concentration, with Al₂O₃ and SnO₂ ALD showing higher-OH groups. Strong peaks at about 1600 cm⁻¹ indicated formation of mono-substituted C═C, which agreed with the defluorination observed in XPS. The loss in fluorine was strongly correlated with the metal oxide deposited for pristine PVDF, except for ZnO and SnO₂ on the alkali activated PVDF. Without being bound by any theory, this may be due to these metal oxides preferring to grow on itself after a few initial cycles. Defluorination may only occur in the few initial cycles when these metal precursors were reacting directly with the polymer. Similarly, —OH groups may be seen after ALD growth on PVDF without any modifications, with the higher hydroxyl groups observed for Al₂O₃, corroborating its lower ALD selectivity. Formation of mono-substituted alkene represented by the appearance of sharp peaks at 1600 cm⁻¹ indicated defluorination during ALD even on pristine PVDF.

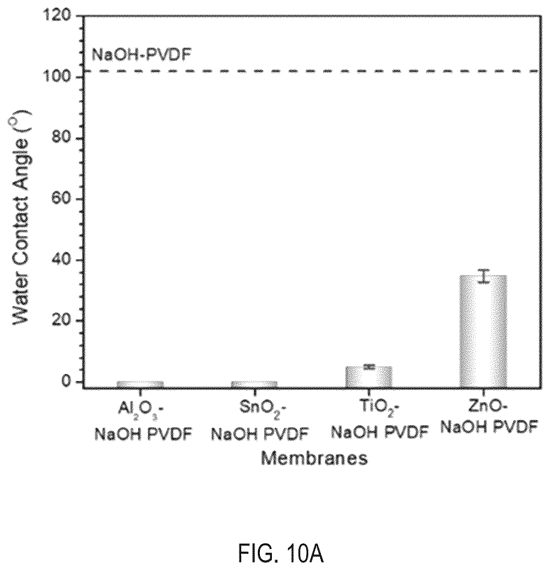

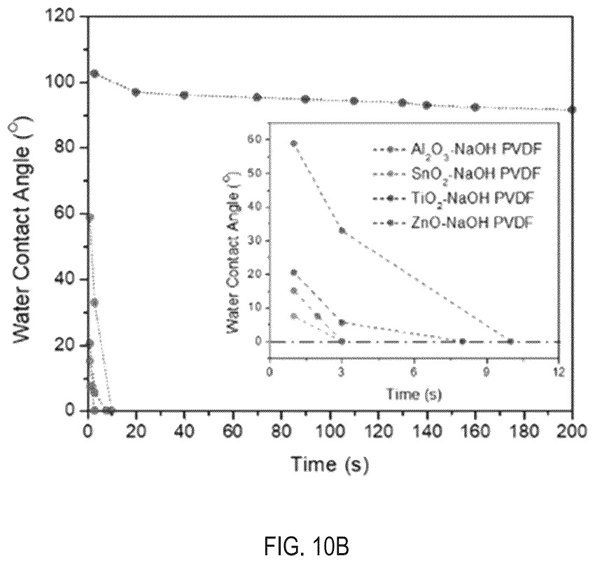

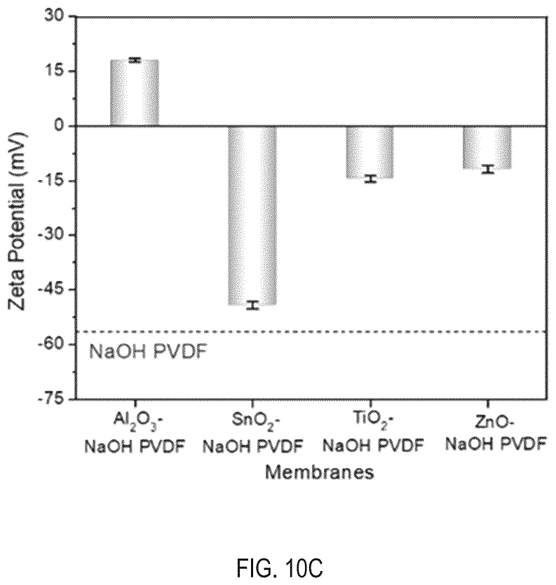

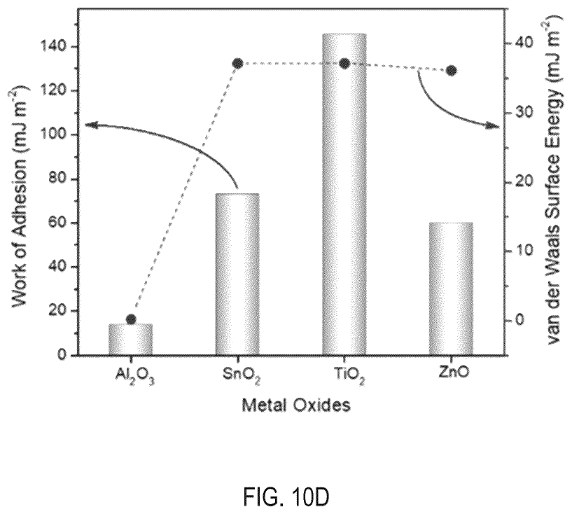

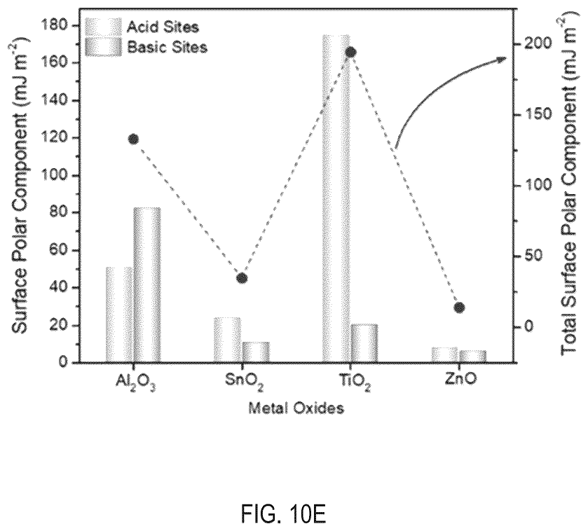

A membrane's capability of separating oil-water emulsion and sustained long term operation may be gauged from the membrane surface wettability and the charge on the surface. Water contact angle (WCA) was measured for activated PVDF membranes surface modified with various metal oxides. Surprisingly, post 3 hour alkali activation, PVDF retained its hydrophobicity with WCA higher than 100°, even though there was about a 47 times increase in oxygen functional groups. However, after just 20 cycles of ALD these SM PVDF membranes became super-hydrophilic for all metal oxides, except for ZnO (FIG. 10A). Among these metal oxides, ZnO typically had higher WCA when deposited via ALD on a silicon wafer, and similar trends of wettability were translated to the SM-PVDF. All the metal oxide SM-PVDF membranes eventually attained WCA of 0° by 10 seconds (FIG. 10B), with ZnO reaching value of 0° slower. Without being bound by any theory, the WCA of 0° may be due to the effects of porosity, surface microstructure and lower ALD growth temperatures. In comparison, the alkali activated PVDF retained WCA above 90° for 200 seconds. In contrast to metal oxide surface modified membranes, PVDF membranes directly modified via ALD maintained hydrophobicity of the PVDF (even after 200 seconds), while some metal oxide ALD resulted in even higher WCA compared to the PVDF. Moreover, these higher WCA were sustained over 200 seconds, indicating that their oil-water separation performance might not be improved compared to pristine PVDF. Underwater oleophobicity of these surface modified membranes were determined by measuring the crude-oil contact angle under water.

The surface charge may have also played a role in solute-membrane interaction and the overall emulsion separation and fouling resistant performance of the membrane, according to the extended Derjaguin-Landau-Verwey-Overbeek (DVLO) theory. Compared to alkali activated PVDF membranes, the charge on the M-SM PVDF membranes was much higher (average change in charge=43.02±0.78), with higher values for Al₂O₃ and lower for SnO₂ (FIG. 10C). The zeta potential followed the order Al₂O₃>TiO₂>ZnO>SnO₂, for SM-PVDF. The high zeta potential compared to PVDF, and alkali activated PVDF indicated potential antifouling characteristics of these metal oxide surface modified membrane. In comparison, after ALD with different metal oxides on pristine PVDF, the zeta potential moved towards positive (average change in zeta potential=4.8±0.52), the extent of which was much less compared to surface modified PVDF membranes. Without being bound by any theory, this may be due to a lower amount of metal oxide deposited on the pristine PVDF using ALD with prior activation.

The interaction between foulant and membrane surface provided an indication of the membrane's fouling behavior. The four different metal oxides were deposited (about 10 nm thickness, ALD at 80° C.) on flat silicon wafers to probe the intrinsic surface energy of these metal oxides. The work of adhesion (W_{ad}, where W_{ad}=γ_{w}×(1+cos θ)) was calculated using contact angle of water (0) on the different metal oxides and surface tension of water (γwᵢ 72.8 mJ m⁻¹). The work of adhesion followed the order TiO₂>SnO₂>ZnO>Al₂O₃ (FIG. 10D). The metal oxide with higher work of adhesion may repel foulant during the filtration process, allowing more consistent permeation throughout the fouling process without blocking of the pores.

Contact angles (θᵢ) were measured on four different metal oxides using three different solvents: water, ethylene glycol and diiodomethane. Using the Oss-Good-Choudhury model (Eq. 9), the Lifshitz-van der Waals

$$( {γ}_{s}^{L W} )$$

and surface polar component due to Lewis acid

$$( {γ}_{s}^{+} )$$

and base sites

$$( {γ}_{s}^{-} ) ,$$

respectively, were calculated using the following equation (for liquids, values of

$${γ}_{l}^{L W} ) :$$

$${γ}_{l} ( 1 + cos {θ}_{i} ) = 2 \sqrt{{γ}_{s}^{L W} {γ}_{l , i}^{L W}} + 2 \sqrt{{γ}_{s}^{+} {γ}_{l , i}^{-}} + 2 \sqrt{{γ}_{s}^{-} {γ}_{l , i}^{+}} \qquad ( 9 )$$

On solving Eq. 9 simultaneously for the three solvents and four different metal oxides, the TiO₂ surface had the higher surface polar component due to Lewis acid, followed by Al₂O₃ surface, whereas Al₂O₃ surface had the higher surface polar component due to Lewis base. However, for Lifshitz-van der Waals, all metal oxides, apart from Al₂O₃ showed similar energy (about 37 mJ m⁻²). Overall, the TiO₂ surface showed the higher sum of polar surface charge

$$( {γ}_{s}^{+} + {γ}_{s}^{-} = 194.6 mJ {m}^{- 2} ) ,$$

which was ~46.3% higher than the metal oxide with the second higher surface energy, i.e., Al₂O₃(FIG. 10E).

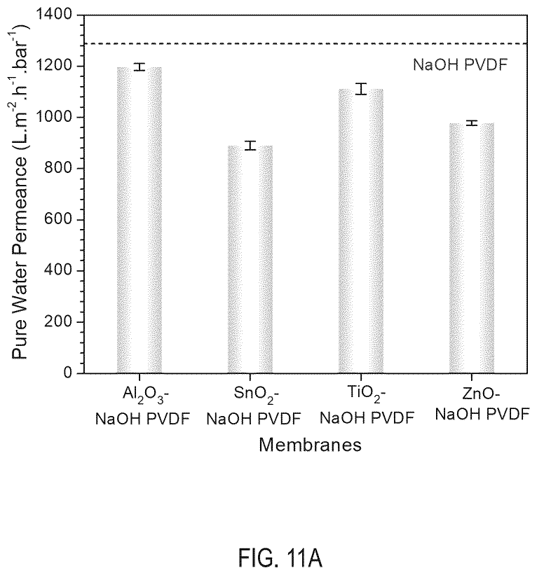

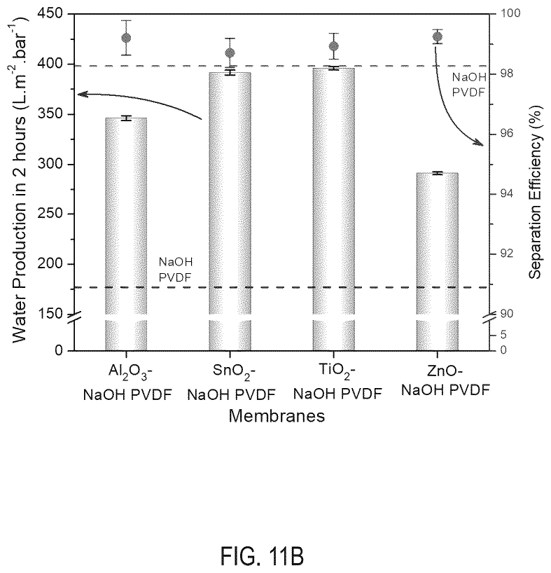

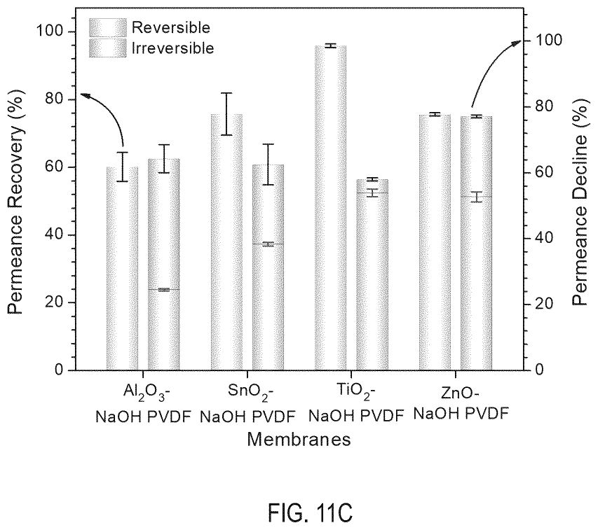

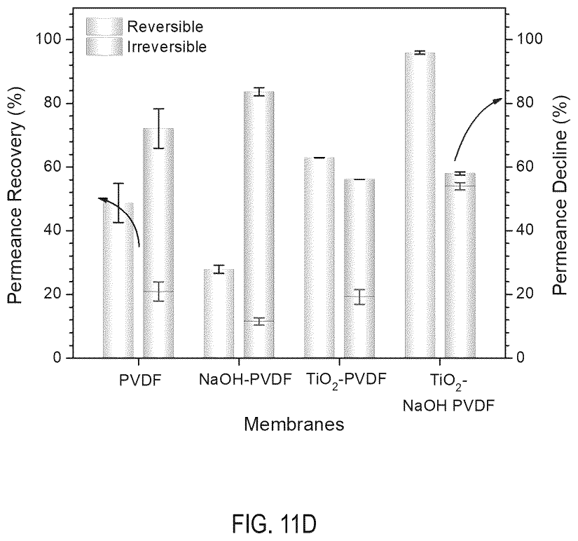

Surface modified membranes were used to separate crude oil-water emulsion by extracting water through pressurized filtration. Filtration experiments were conducted in a filtration system using compressed argon to maintain transmembrane pressure. Prior to testing these membranes for emulsion separation, pure water permeance through these membranes was measured. The alkali activated membranes prior to surface engineering via ALD demonstrated 188.5% increase in pure water permeance, compared to pristine PVDF which had a steady-state water permeance of 589.0 L·m⁻²·h⁻¹·bar⁻¹ (FIG. 11A). Without being bound by any theory, this increase in water permeance may be due to the surface functionalization due to the incorporation of oxygen containing functional groups during the alkali activation. Post surface engineering, there was a slight drop in water permeance (for example, about 14% for Ti-SM PVDF membrane, with larger change of about 30% obtained for Sn-SM PVDF). The same number of cycles of ALD on the pristine PVDF membrane yielded little change in the pure water permeance, with only 6% improvement for Al-PVDF and up to 30% loss for Zn-PVDF. These changes may be attributed to surface functionalization.

SM-PVDF membranes with different metal oxides were used for crude oil separation. Efficiency of separation and the throughput during the operation were measured. For membranes with ever changing throughput during fouling, the total permeate volume produced in a time period served as a criterion. Over a 2 hour period of operation, the pristine PVDF reclaimed 180.37 liters of water from the crude oil emulsion per square meter of membrane area while operating under 1 bar transmembrane pressure. In contrast, the alkali activated PVDF showed similar water production (176.99 L·m⁻²·bar⁻¹), in spite of having 188.5% higher pure water permeance. This result indicated that a membrane with higher pure water permeance after modification did not translate to an anti-fouling membrane. However, compared to pristine and alkali activated PVDF, the SM PVDF membranes showed at least 64.4% higher water production (FIG. 11B), with Ti-SM PVDF exhibiting an increase in water production of over 123.5% (395.8 L·m⁻²·bar⁻¹).

Another metric that may indicate a membrane's longevity is the permeance recovery rate (PRR), and the reversible and irreversible fouling components. Among the various SM PVDF membrane, the Ti-SM PVDF showed the higher permeance recovery (PRR>95%), while demonstrating the lower irreversible permeance loss (about 4%) among the various metal oxide SM PVDF membranes (FIG. 11C). These results indicated that even though PVDF modification through surface engineering with TiO₂ did not yield the higher water permeance, its crude oil emulsion separation performance was better among the four M-SM PVDF membranes. Moreover, Sn-SM PVDF demonstrated more permeance decrease (30.9%) from alkali activated PVDF, and demonstrated the second-better performance for crude oil-water emulsion separation. Ti-SM PVDF showed the better crude oil-water emulsion separation performance, owing to its antifouling behavior. However, the assessment for other metal oxides was not corelated with their SM PVDF membranes. Thus, without being bound by any theory, antifouling behavior may not be just a function of metal oxide functionalization, but depend on a combination of factors such as surface roughness and nano-structured morphology of the surface modified metal oxides layers. Nevertheless, the surface engineering improved water production by at least 61% (with a larger amount of about 120% for Ti-SM PVDF) compared to pristine PVDF along with higher membrane performance recovery after washing (FIG. 11C). However, the same number of ALD cycles on pristine PVDF without any activation resulted in almost no improvement in terms of separation efficiency and membrane longevity.

Compared to the pristine PVDF membranes, the metal oxide SM-PVDF membranes performed exceptionally well for extracting water from extremely challenging crude oil-water separation. In terms of membrane performance recovery, Ti-SM PVDF showed >95% PRR, compared to only 48.7% for PVDF (FIG. 11D). Alkali activated PVDF, although showing slight improvement of hydrophilicity (WCA reduction by ~30°), exhibited PRR that was even lower (27.8%) than pristine PVDF. Without being bound by any theory, this may be due to lower surface charge (FIG. 9C) of alkali treated PVDF which increased propensity of fouling. In comparison, ALD-treated pristine PVDF membrane also performed poorly, with only 63% PRR and higher fraction of irreversible fouling and low pure water permeance. These comparison examples suggest the importance of surface engineering, which provided a good combination of high surface energy, superhydrophilicity, and appropriate surface nanostructure to provide a strong hydration layer at the interface, hindering attachment of crude oil molecules to the membrane surface. In particular, Ti-SM PVDF shows the better performance among the various SM PVDF membrane.

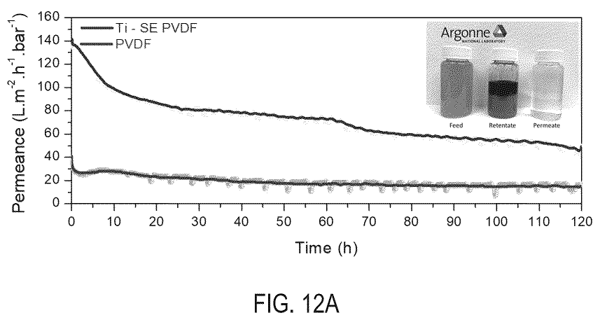

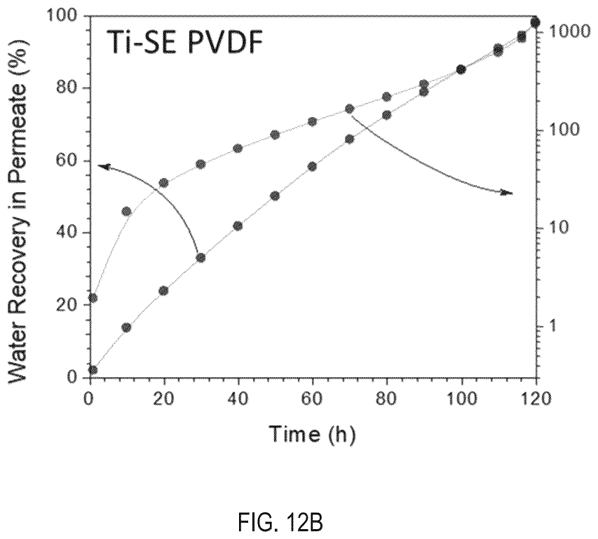

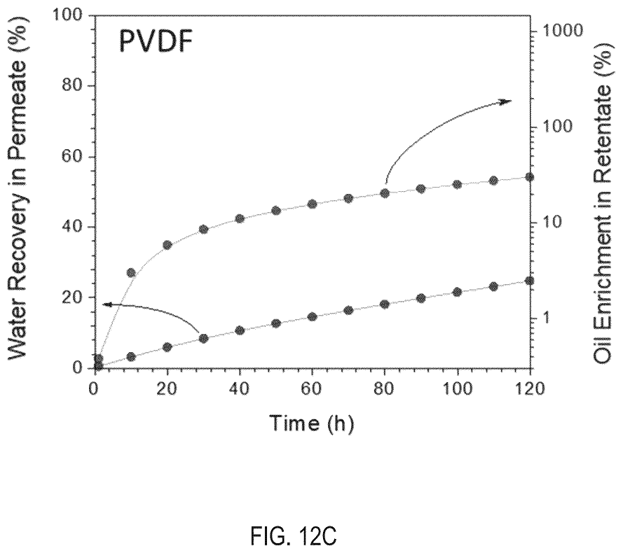

Ti-SM PVDF membranes were subjected to long term water recovery for crude oil-water emulsion containing 5 volume % crude oil. As a comparison experiment, a pristine PVDF membrane was subjected to the same test. For a 120 hour long filtration, Ti-SM PVDF recovered water with higher initial permeance (~135 L·m⁻²·h⁻¹·bar⁻¹) and underwent a drop of 64.9% permeance over the 120-hour water recovery period (FIG. 12A). In contrast, the pristine PVDF underwent only a slightly lower permeance drop during the 120-hour period (60.9%) but started with a much lower initial permeance (~41 L·m⁻²·h⁻¹·bar⁻¹). Moreover, 90% of the permeance loss for pristine PVDF occurred in the first 40-hours of the operation. Hence, it was only able to process 28.9% of the total volume of feed (total feed=185.2 g) over the 120-hours of operation, whereas the Ti-SM PVDF membrane processed over 92.8% of the feed. The water recovery and oil enrichment were measured for the Ti-SM PVDF and the pristine PVDF membranes. Over the 120-hour period, the Ti-SM PVDF recovered 97.7% of the water from the oil-water emulsion, while maintaining high separation efficiency (FIG. 12B). While water permeated through the membrane maintained purity around 99.96%, the oil in the retentate got enriched by ~1290%. The final retentate contained about 70 vol. % crude oil compared to 5 volume % crude oil the starting feed (FIG. 12B). In contrast, the pristine PVDF membrane, during its 120-hour operation, recovered only 24.6% of the water from the feed, and enriched the oil in the retentate by about 30% (FIG. 12C). The comparison example using PVDF was operated for 190 hours, at which the water recovery increased to 36.01% while oil enrichment reached 51.2%. During the timeframe of operation, the water quality (99.92% water in permeate) of the permeate through PVDF membrane was comparable to Ti-SM PVDF. For the PVDF membrane, the time it would take to reach >97% water recovery was predicted, with an inflated assumption that the membrane would retain the same value of permeance which it attained after the first 40-hour period. Even under such assumption, the pristine PVDF would require about 580 hours to reach the level of separation demonstrated by Ti-SM PVDF, which is about 4.85 times more. In an attempt to recover >97% water in the permeate, the PVDF membrane enriched the oil in feed by 1190%, with 64.5% oil in retentate, compared to about 70% crude oil in retentate for Ti-SM PVDF (FIGS. 12B and 12C). Moreover, due to the longer filtration time and marginally lower separation efficiency, a higher amount of crude oil passed through the PVDF membrane pores into the recovered water in permeate. Hence, it exhibited slightly lower oil recovery after predicted 580 hours of operation compared to 120 hours of operation of Ti-SM PVDF membrane.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method comprising:
contacting a membrane comprising polyvinylidene fluoride (PVDF) with a solution comprising about 4 N to about 10 N hydroxide in water at a temperature of about 65° C. to about 85° C. for about 0.5 hours to about 24 hours to form a pretreated membrane; and
depositing a coating on the pretreated membrane by a vapor-phase deposition process to form a coated membrane, the depositing including:
(A) contacting the pretreated membrane with a precursor gas to adsorb or form a precursor complex on a surface of the pretreated membrane; and
(B) contacting the pretreated membrane with a co-reactant, the co-reactant reactive with the adsorbed precursor gas or precursor complex.

2. The method of claim 1, wherein the solution comprises sodium hydroxide, potassium hydroxide, barium hydroxide, calcium hydroxide, lithium hydroxide, rubidium hydroxide, magnesium hydroxide, trimethylammonium hydroxide, or a combination of any two or more thereof.

3. The method of claim 1, wherein contacting the membrane comprises contacting the membrane with the solution for about 0.5 hours to about 5 hours at a temperature of about 70° C. to about 80° C., wherein the solution is about 4 N to about 5 N sodium hydroxide in water.

4. The method of claim 1, wherein depositing the coating comprises:
providing the pretreated membrane in an atomic layer deposition (ALD) reactor;
contacting the pretreated membrane with the precursor gas in the ALD reactor while heating the pretreated membrane at a temperature of about 50° C. to about 110° C.; and
contacting the pretreated membrane with the co-reactant in the ALD reactor while heating the pretreated membrane at a temperature of about 50° C. to about 110° C.

5. The method of claim 1, wherein the precursor gas comprises an aluminum precursor, a zinc precursor, a titanium precursor, a tin precursor, a zirconium precursor, a silicon precursor, a niobium precursor, or a combination of any two or more thereof.

6. The method of claim 1, wherein the precursor gas comprises trimethyl aluminum (TMA), triethyl aluminum, aluminum chloride, dimethyl aluminum isopropoxide, aluminum bromide, aluminum t-butoxide, tris(dimethylamido)aluminum (III), aluminumacetylacetonate, or aluminum isopropoxide.

7. The method of claim 1, wherein the co-reactant is selected from water (H₂O), oxygen (O), ozone (O₃), hydrogen peroxide (H₂O₂), nitrous oxide (N₂O), or a combination of any two or more thereof.

8. The method of claim 1, wherein depositing the coating further includes repeating steps (A) and (B) 1 to 50 times.

9. The method of claim 1, wherein the membrane comprises pores having a diameter of about 10 nm to 99 nm.

10. The method of claim 1, wherein the membrane comprises pores having a diameter of about 0.1 μm to about 10 μm.

11. The method of claim 1, further comprising contacting the membrane with alcohol prior to contacting the membrane with the solution comprising hydroxide.

12. A membrane comprising:
polyvinylidene fluoride (PVDF) with pores formed therein having a diameter of about 10 nm to 10 μm; and
a metal oxide coating disposed on the PVDF, the metal oxide coating having a thickness of about 0.1 nm to about 20 nm;
wherein the membrane has a water permeance of about 1000 L·m⁻²·h⁻¹·bar⁻¹ to about 1300 L·m⁻²·h⁻¹·bar⁻¹ and a flux recovery of about 80% to about 99.9%.

13. The membrane of claim 12, wherein the pores have a diameter of about 10 nm to about 99 nm.

14. The membrane of claim 12, wherein the pores have a diameter of about 0.1 μm to about 10 μm.

15. The membrane of claim 12, wherein the metal oxide coating comprises aluminum oxide, zinc oxide, titanium oxide, tin oxide, zirconium oxide, silicon oxide, niobium oxide, or a combination of any two or more thereof.

16. A method of filtering an aqueous liquid comprising:
passing the aqueous liquid through a membrane at a permeance of about 1000 L·m⁻²·h⁻¹·bar⁻¹ to about 1300 L·m⁻²·h⁻¹·bar⁻¹;
backwashing the membrane; and
after backwashing, passing the aqueous liquid through the membrane again with a flux recovery of about 80% to about 99.9%.

17. The method of claim 16, wherein the membrane comprises:
polyvinylidene fluoride (PVDF) with pores formed therein having a diameter of about 10 nm to 10 μm; and
a metal oxide coating disposed on the PVDF, the metal oxide coating having a thickness of about 0.1 nm to about 20 nm.

18. The method of claim 17, wherein the pores have a diameter of about 10 nm to 99 nm.

19. The method of claim 17, wherein the pores have a diameter of about 0.1 μm to about 10 μm.

20. The method of claim 17, wherein the metal oxide coating comprises aluminum oxide, zinc oxide, titanium oxide, tin oxide, zirconium oxide, silicon oxide, niobium oxide, or a combination of any two or more thereof.
